(19) United States
(12) Patent Application Publication
(10) Pub. No.: US 2026/0282016 A1
(43) Pub. Date: Sep. 17, 2026

(54) ENHANCED PRECODING INDICATION FOR UPLINK TRANSMISSION

(71) Applicant: INTERDIGITAL PATENT HOLDINGS, INC., Wilmington, DE (US)

(72) Inventors: Afshin HAGHIGHAT, Ile-Bizard (CA); Jonghyun PARK, Syosset, NY (US); Loic CANONNE-VELASQUEZ, Dorval (CA); Moon IL LEE, Melville, NY (US); Mohammad IRFAN, Chateauguay (CA)

(73) Assignee: INTERDIGITAL PATENT HOLDINGS, INC., Wilmington, DE (US)

(21) Appl. No.: 19/111,541

(22) PCT Filed: Sep. 29, 2023
(86) PCT No.: PCT/US2023/034092

§ 371 Date: Mar. 13, 2025

Related U.S. Application Data
(60) Provisional application No. 63/411,348, filed on Sep. 29, 2022.
(60) Provisional application No. 63/445,357, filed on Feb. 14, 2023.
(60) Provisional application No. 63/455,790, filed on Mar. 30, 2023.
(60) Provisional application No. 63/465,666, filed on May 11, 2023.

(51) Int. Cl. H04W 72/21; H04B 7/06; H04L 1/00

(52) U.S. Cl. CPC H04W 72/21; H04B 7/0639; H04L 1/0003

(57) ABSTRACT

A wireless transmit/receive unit (WTRU) may determine precoding codebooks. The WTRU may receive downlink control information (DCI) scheduling an uplink transmission. The DCI may include rank information, precoder information, a first indication associated with a first codeword (CW), and a second indication. Further, the WTRU may determine, based on the rank information, a subset of the precoding codebooks. The WTRU may determine, on a condition that the rank information indicates that the rank is less than or equal to a threshold value, a precoder from the subset of the precoding codebooks, based on the precoder information and at least part of the second indication. Moreover, the WTRU may transmit, based on the first indication and using the precoder, the first CW in the uplink transmission. In an example, the second indication may be associated with the second CW. In another example, the second indication may be associated with precoder selection.

### CROSS-REFERENCE TO RELATED APPLICATIONS

This application claims the benefit of U.S. Provisional Application No. 63/411,348, filed Sep. 29, 2022, U.S. Provisional Application No. 63/445,357, filed Feb. 14, 2023, U.S. Provisional Application No. 63/455,790, filed Mar. 30, 2023, and U.S. Provisional Application No. 63/465,666, filed May 11, 2023, the contents of which are incorporated herein by reference.

### BACKGROUND

In multiple input multiple output (MIMO) communications, to enhance coverage, reliability and throughput of communications, for certain categories of wireless transmit/receive units (WTRUs), some enhancements for uplink transmission are considered for development. Enhancements considered include uplink demodulation reference signal (DM-RS), sounding reference signal (SRS), SRS resource indicator (SRI), and transmit precoding matrix indicator (TPMI) enhancements to enable eight (8) transmission (Tx) antenna uplink operation to support four (4) or more layers per WTRU, in uplink targeting customer premises equipment (CPE)/fixed wireless access (FWA)/vehicle/industrial devices. Further enhancements may involve a coherence assumption, a full power mode, a non-full power mode and the like.

In current communications, a WTRU receives a TPMI in scheduling downlink control information (DCI) and uses the scheduling DCI to determine the precoding matrix required for the transmission. Further, code-book based precoding may also be used.

### SUMMARY

A wireless transmit/receive unit (WTRU) may receive a low overhead transmit precoding matrix indicator (TPMI)/sounding reference signal (SRS) resource indicator (SRI) indication. Further, the WTRU may receive a codebook subset restriction indication. Also, the WTRU may transmit an uplink transmission based on uplink precoding. In an example, the uplink precoding may be based on the received low overhead TPMI/SRI indication and the received codebook subset restriction indication. In an example, the codebook subset restriction indication may be received in a medium access control (MAC) control element (CE). In a further example, the codebook subset restriction indication may be received in downlink control information (DCI).

In another example, the WTRU may receive an antenna group index (AGI) and the uplink precoding may be further based on the received AGI. In an additional example, the WTRU may receive a transmission rank and the uplink precoding may be further based on the received transmission rank. In yet another example, WTRU may receive a mapping table and the uplink precoding may be further based on the received mapping table. In still another example, WTRU may receive a scheduling grant and the uplink precoding may be further based on the received scheduling grant. Further, the WTRU may transmit SRS transmissions. In a further example, the TPMI/SRI indication may be associated with a pre-coded SRS resource.

In an additional example, the WTRU may receive a channel state information (CSI) reporting configuration. Further, the WTRU may generate a sub-codebook based on the received CSI reporting configuration, the received low overhead TPMI/SRI indication and the received codebook subset restriction indication. Also, the uplink precoding may be further based on the sub-codebook. Moreover, the WTRU may transmit uplink control information (UCI) including a number of precoders in the sub-codebook. In a further examples, the UCI may include a preferred number of co-phases. Additionally, the WTRU may generate the sub-codebook by reducing a number of co-phases.

In a further example, a WTRU may receive concatenated bit fields corresponding to activated antenna ports. Additionally or alternatively, the WTRU may receive a first SRI index. The WTRU may then determine a first set of ports based on the first SRI index. Also, the WTRU may receive a second SRI index. The WTRU may then determine one or more offset values for a second set of ports based on the second SRI index.

A WTRU may determine one or more precoding codebooks. The WTRU may receive DCI scheduling an uplink transmission. The DCI may include rank information, precoder information, a first indication associated with a first codeword (CW), and a second indication. Further, the WTRU may determine, based on the rank information, a subset of the one or more precoding codebooks. Also, the WTRU may determine, on a condition that the rank information indicates that the rank is less than or equal to a threshold value, a precoder from the subset of the one or more precoding codebooks, based on the precoder information and at least part of the second indication. Moreover, the WTRU may transmit, based on the first indication and using the precoder, the first CW in the uplink transmission. In an example, the second indication may be associated with the second CW. In another example, the second indication may be associated with precoder selection. In an example, the threshold value may be four (4).

In a further example, the second indication may be associated with precoder selection, on a condition that the rank information indicates that the rank is less than or equal to the threshold value. In a further example, the second indication may be associated with the second CW, on a condition that the rank information indicates that the rank greater than the threshold value.

Moreover, the WTRU may transmit, based on the second indication, the second CW using the precoder information. In an example, the second indication may indicate a modulation and coding scheme (MCS). In another example, the second indication may indicate a redundancy version (RV). In a further example, the second indication may indicate whether new data is to be transmitted.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example uplink precoding mechanism;

FIG. 3 is a configuration diagram illustrating an example WTRU antenna configuration for WTRU transmission;

FIG. 4 is a system diagram illustrating an example of uplink precoding according to antenna grouping;

FIG. 5 is a system diagram illustrating an example of mapping of a transmit precoding matrix indicator (TPMI) indication as a function of the antenna group index (AGI);

FIG. 6 is a flowchart diagram illustrating an example of codebook subset selection and support of high resolution uplink precoding;

FIG. 7 is a flowchart diagram illustrating another example of codebook subset selection;

FIG. 8 is a system diagram illustrating an example of a general precoding structure;

FIG. 9 is a graph diagram illustrating an example of a comparison of mean chordal distance using different selection criteria;

FIG. 10 is a codebook diagram illustrating an example of a downlink (DL) codebook at a parent codebook with precoders; and

FIG. 11 is a codebook diagram illustrating an example of a reduced codebook.

### DETAILED DESCRIPTION

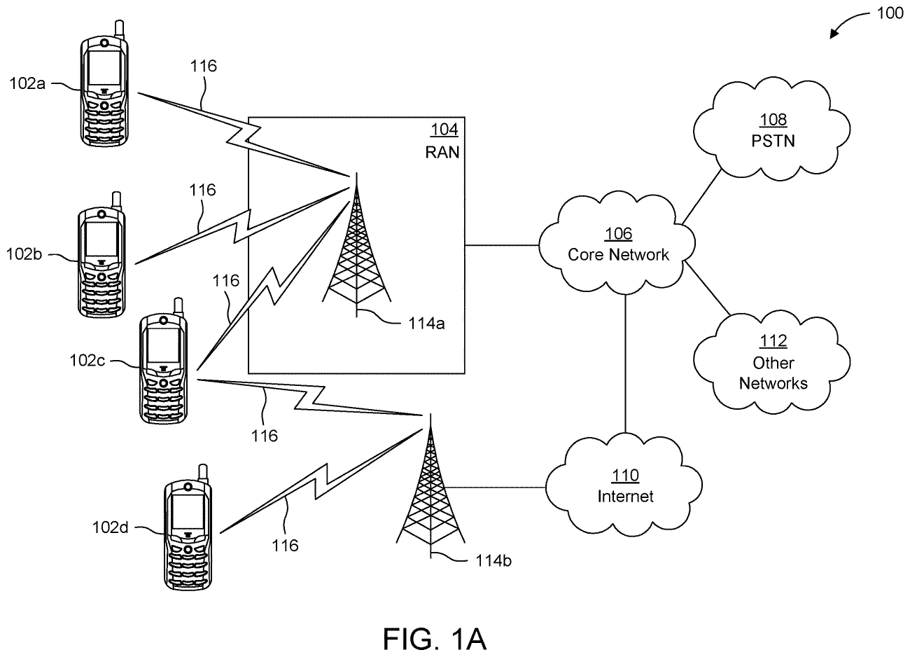

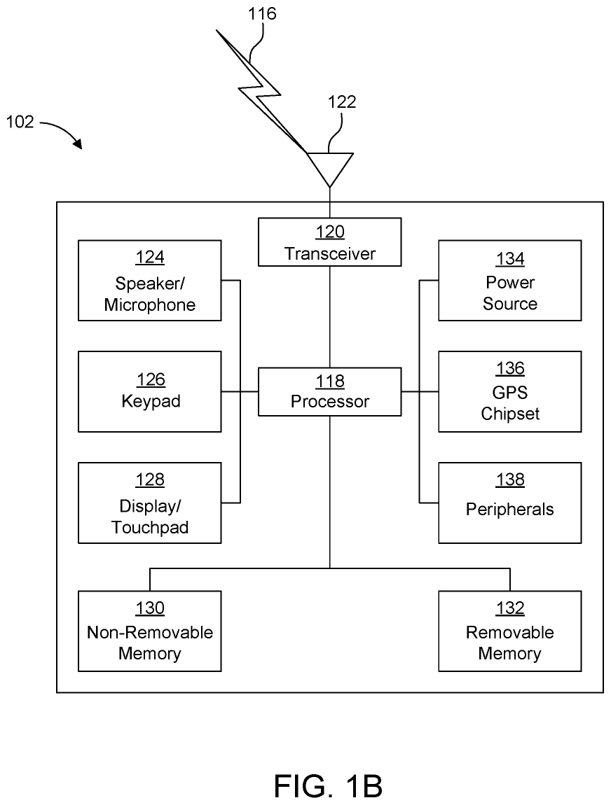

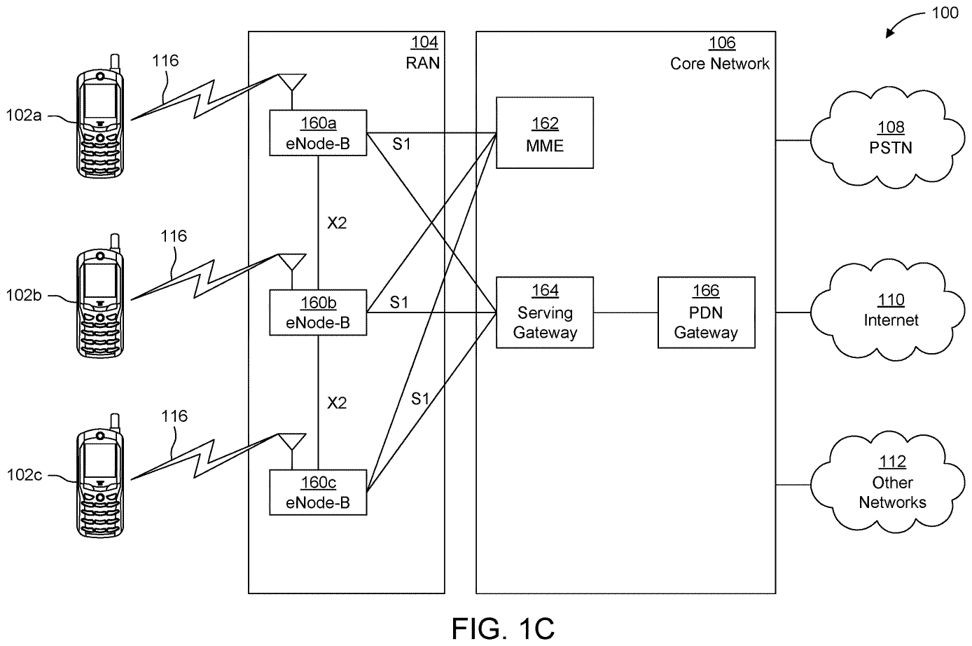

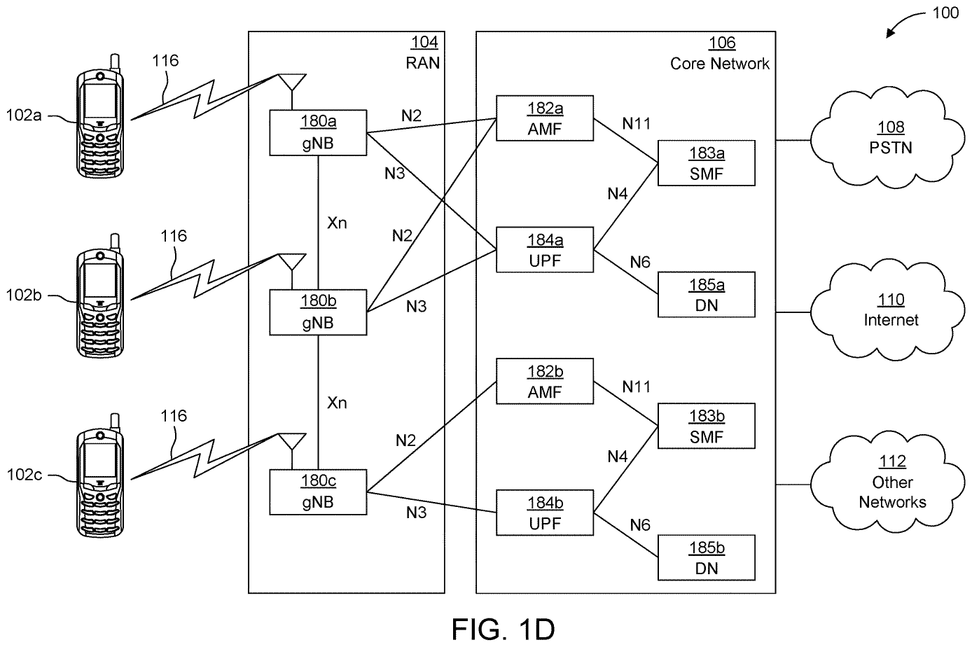

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In MIMO communications, to enhance coverage, reliability and throughput of communications, for certain categories of WTRUs, some enhancements for uplink transmission are considered for development. Enhancements considered include uplink demodulation reference signal (DM-RS), sounding reference signal (SRS), SRS resource indicator (SRI), and transmit precoding matrix indicator (TPMI) enhancements to enable eight (8) transmission (Tx) antenna uplink operation to support four (4) or more layers per WTRU, in uplink targeting customer premises equipment (CPE)/fixed wireless access (FWA)/vehicle/industrial devices. Further enhancements may involve a coherence assumption, a full power mode, a non-full power mode and the like.

In current communications, a WTRU receives a TPMI in scheduling downlink control information (DCI) and uses the scheduling DCI to determine the precoding matrix required for the transmission. Further, code-book based precoding may also be used.

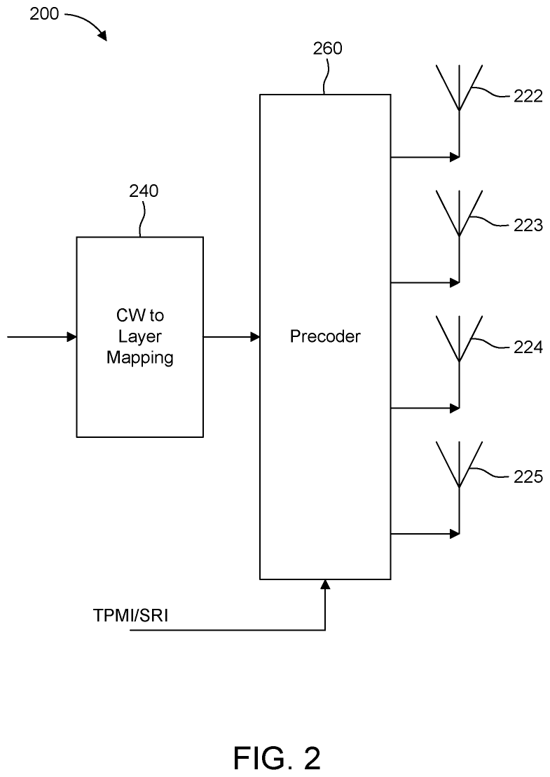

FIG. 2 is a system diagram illustrating an example uplink precoding mechanism. An example shown in system diagram 200 includes a codebook-based uplink precoding mechanism. In a codebook-based uplink precoding, a WTRU receives information related to rank, preferred precoding, and preferred beam for uplink transmission in a scheduling DCI. For example, the relevant set of information for uplink precoding received in a DCI Format 0_1 can be summarized as follows. The set of information includes TPMI and the number of layers, taking up to zero (0) to six (6) bits, and precoding options for single layer, two-layer, three-layer and four-layer transmission. The set of information indicates the transmission beam, including an SRS resource set indicator, which may be zero (0) or two (2) bits, with a configuration of multiple SRS resource sets to support multi-transmission/reception point (mTRP) uplink transmission. The set of information also indicates an SRI, which may be zero (0) or two (2) bits.

| In an example of uplink processing shown in FIG. 2, codeword (CW) to layer mapping may be performed on data for a CW at module 240. Then, the output of module 220 may then be used as input for precoder 260, which may apply the received TPMI, the received SRI or both to the CW. The CW may then be transmitted by transmit/receive elements 222, 223, 224, 225. In an example, the transmit/receive elements 222, 223, 224, 225 may be configured to transmit signals to a base station, such as for example, the base station 114a over the air interface 116 shown in FIG. 1A. In further example, the transmit/receive element 222, 223, 224, 225 may be antennas configured to transmit and/or receive RF signals.

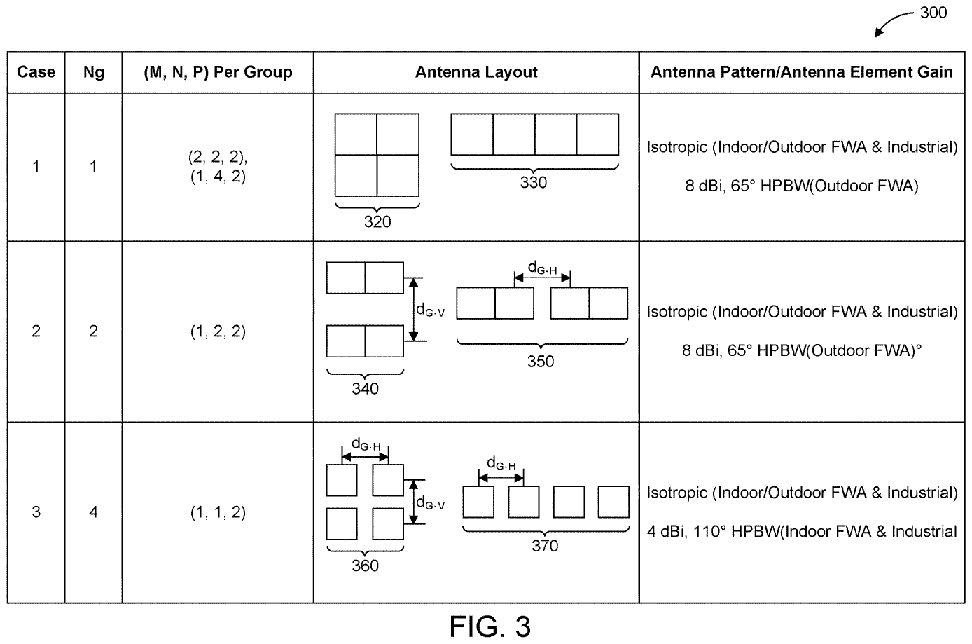

FIG. 3 is a configuration diagram illustrating an example WTRU antenna configuration for WTRU transmission. In an example shown in configuration diagram 300, an Ng equal to or greater than one antenna groups can be considered where each group comprises coherent antennas, and across groups, antennas can be non-coherent/coherent depending on device types. An example of an antenna group can be a panel. A linear array (1D/2D) of cross-polarized or single-polarized antenna configuration can be considered. Within an antenna group, antenna elements are uniformly spaced.

To support codebook-based uplink transmission for an 8 Tx WTRU uplink transmission, two main categories, namely, Alt1-b and Alt2-a are used. Category Alt1-b includes uplink 2 Tx/4 Tx codebooks and/or 8×1 antenna selection vector(s) as the starting point for design of the codebook for partially/non-coherent WTRUs, and downlink Type I codebook as the starting point for design of the codebook for fully-coherent WTRUs. Category Alt2-a includes uplink 2Tx/4Tx codebooks and/or 8×1 antenna selection vector(s) as the starting point for design of codebook for fully/partially/non-coherent WTRUs.

As shown in configuration diagram 300, in Case 1, Ng is equal to 1 showing one antenna group. Further, in Case 1, antenna layout 320 and antenna layout 330. Antenna layout 320 has an M of 2 showing 2 rows of antennas, an N of 2 showing 2 columns of antennas, and a P of 2 showing that there are 2 cross polarized antennas in each of the four squares in the layout. Accordingly, antenna layout 320 has 8 antennas in a group.

Also, antenna layout 330 in Case 1 has an M of 1 showing 1 row of antennas, an N of 2 showing 2 columns of antennas, and a P of 2 showing that there are 2 cross polarized antennas in each of the four squares in the layout. Accordingly, antenna layout 330 has 8 antennas in a group.

Moreover, antenna layout 320 and antenna layout 330 both have isotropic antenna patterns. They both also may have indoor FWA, outdoor FWA or industrial applications. Further, both antenna layout 320 and antenna layout 330 both have an 8 decibels relative to isotropic (dBi) antenna element gain and a 65 degree half-power beamwidth (HPBW) for outdoor FWA applications.

Further, as shown in configuration diagram 300, in Case 2, Ng is equal to 2 showing two antenna groups. Also, in case 2, antenna layout 340 has an M of 1 showing 1 row of antennas in each group, and each group is separated in a vertical direction by an arbitrary distance of d_{G-V}, an N of 2 showing 2 columns of antennas, and a P of 2 showing that there are 2 cross polarized antennas in each of the four squares in the layout. Accordingly, antenna layout 340 has 8 antennas in two groups. As seen in FIG. 3, antenna layout 340 has a zero distance in the horizontal direction between groups.

In addition, antenna layout 350 in Case 2 has an M of 1 showing 1 row of antennas, and each group is separated in a horizontal direction by an arbitrary distance of d_{G-H}. Further, antenna layout 350 has an N of 2 showing 2 columns of antennas in each group, and a P of 2 showing that there are 2 cross polarized antennas in each of the four squares in the group. In this way, antenna layout 350 has 8 antennas in two groups.

Additionally, antenna layout 340 and antenna layout 350 both have isotropic antenna patterns. They both also may have indoor FWA, outdoor FWA or industrial applications. Further, both antenna layout 340 and antenna layout 350 both have an 8 dBi antenna element gain and a 65 degree HPBW for outdoor FWA applications.

Also, as shown in configuration diagram 300, in Case 3, Ng is equal to 4 showing four antenna groups. For example, in antenna layout 360 each group is separated in both a vertical direction and a horizontal direction. Each group of antenna layout 360 has an M of 1 showing 1 row of antennas, an N of 1 showing 1 column of antennas, and a P of 2 showing that there are 2 cross polarized antennas in each of the four squares in the layout. Each group is separated in a horizontal direction by an arbitrary distance of d_{G-H} and separated in a vertical direction by an arbitrary distance of d_{G-V}. In this way, antenna layout 360 has 8 antennas in four groups.

Further, as shown in configuration diagram 300, in Case 3, antenna layout 370 is broken into four groups, with each group separated in a horizontal direction by an arbitrary distance of d_{G-H}. Each part of antenna layout 370 has an M of 1 showing 1 row of antennas, an N of 1 showing 1 column of antennas, and a P of 2 showing that there are 2 cross polarized antennas in each of the four squares in the layout. Accordingly, antenna layout 360 has 8 antennas in four groups.

Similarly to the other antenna layouts in FIG. 3, antenna layout 360 and antenna layout 370 both have isotropic antenna patterns. They both also may have indoor FWA, outdoor FWA or industrial applications. Further, both antenna layout 360 and antenna layout 360 have a 4 dBi antenna element gain and a 110 degree HPBW for outdoor FWA applications.

Given the scope of recent enhancements to wireless communications, a larger overhead for indication of information related to rank, preferred precoding, and preferred beam for uplink transmission is expected. However, to maintain spectrum efficiency of the wireless network, low overhead solutions for SRI and/or transmitter precoder matrix indication for codebook-based, and SRI indication for non-codebook-based uplink transmission become advantageous.

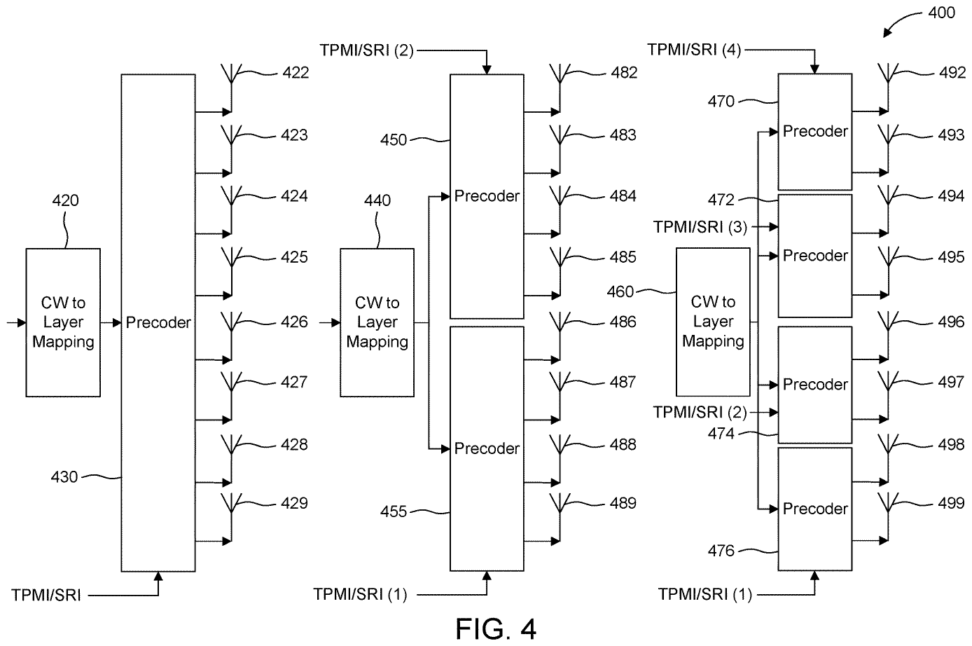

FIG. 4 is a system diagram illustrating an example of uplink precoding according to antenna grouping. As shown in an example in system diagram 400, the three precoding structures each perform CW to layer mapping on data for a CW. For example, in an example in the left-most precoding structure in FIG. 4, module 420 performs CW to layer mapping on data for a CW. Further, the output of module 420 may then be used as input for precoder 430, which may apply a received TPMI indication, a received SRI indication or both to the CW. The CW may then be transmitted by eight antennas 422, 423, 424, 425, 426, 427, 428, 429. In an example, the eight antennas 422, 423, 424, 425, 426, 427, 428, 429 may transmit signals to a base station, such as for example, the base station 114a over the air interface 116 shown in FIG. 1A.

Further, in an example shown in the center precoding structure in FIG. 4, module 440 performs CW to layer mapping on data for a CW. Further, the output of module 440 may then be used as input for two precoders 450, 455. Precoder 455 may apply a first received TPMI indication, a first received SRI indication or both to the CW. Further, precoder 450 may apply a second received TPMI indication, a second received SRI indication or both to the CW. The CW from precoder 450 may then be transmitted by four antennas 482, 483, 484, 485. Also, Also, the CW from precoder 455 may then be transmitted by four antennas 486, 487, 488, 489. In an example, antennas 482, 483, 484, 485, 486, 487, 488, 489 may transmit signals to a base station, such as for example, the base station 114a over the air interface 116 shown in FIG. 1A.

In another example, shown in the right-most precoding structure in FIG. 4, module 460 performs CW to layer mapping on data for a CW. Further, the output of module 460 may then be used as input for four precoders 470, 472, 474, 476. Precoder 476 may apply a first received TPMI indication, a first received SRI indication or both to the CW. Further, precoder 474 may apply a second received TPMI indication, a second received SRI indication or both to the CW. Similarly, precoder 472 may apply a third received TPMI indication, a third received SRI indication or both to the CW. Likewise, precoder 470 may apply a fourth received TPMI indication, a fourth received SRI indication or both to the CW. The CW from precoder 470 may then be transmitted by two antennas 492, 493, the CW from precoder 472 may then be transmitted by two antennas 494, 495, the CW from precoder 474 may then be transmitted by two antennas 496, 497, and the CW from precoder 476 may then be transmitted by two antennas 498, 499.

The CW may then be transmitted by eight antennas 492, 493, 494, 495, 496, 497, 498, 499. In an example, the eight antennas 492, 493, 494, 495, 496, 497, 498, 499 may be configured to transmit signals to a base station, such as for example, the base station 114a over the air interface 116 shown in FIG. 1A.

Based on the overall precoding structure shown in FIG. 4, for supporting uplink precoding with a larger number of antennas for MIMO or NR MIMO, some enhancements in codebook structure and indication become advantageous. In particular, examples provided herein address the following issues for 8 Tx WTRUs. The examples provided herein address control signaling, reduce overhead, or both, associated with an SRI/TPMI indication, which may be used for one or both of Alt1-b and Alt2-a. Also, examples provided herein address a unified indication for both coherent and non-/partial coherent WTRUs, which may be used for one or both of Alt1-b and Alt2-a. As used in the examples and embodiments herein, the phrases antenna panel, antenna group, and antenna port group may be used interchangeably.

Examples and embodiments following include a low overhead TPMI/SRI indication. A partitioning precoding structure for a per antenna group TPMI/SRI indication is included in the following examples and embodiments. For an uplink transmission, a WTRU may partition an M-TX antenna set to K antenna groups comprising of N TX antennas per antenna group, where N≤M. It may be further assumed that the antennas within each antenna group are coherent. For the brevity of presentation of the main idea, it is assumed that each antenna group has a same number of TX antennas, however the same presented solutions below may be applied for the cases where antenna groups have a different number of TX antennas.

To determine the uplink precoder, a WTRU may receive K_TPMI TPMI and K_SRI SRI indications, where K_TPMI≤K, K_SRI≤K. In a solution, a WTRU may receive more than one TPMI/SRI indication, e.g., two indications, where a first indication selects a TPMI/SRI value from a first set of possible TPMI/SRI values, and a second indication selects a TPMI/SRI value from a second set of possible TPMI/SRI values. Such an approach may be implemented in an example in the center precoding structure shown in FIG. 4.

Examples and embodiments following include different SRI/TPMI set size per antenna group. For each antenna group, the size and combination of each possible set of SRI/TPMI values may be different than the other groups. For example, there may be more choices of TPMI/SRI for the first antenna group, and less choices for the remaining groups. In an exemplary solution, there may be K1_TPMI possible choices for the first indication, and for K2_TPMI possible choices for the second indication, where K1_TPMI>K2_TPMI. In a solution, when a WTRU receives K1_TPMI indications, it may also receive (K1_TPMI−1) or less indicator to determine the co-phasing between each set of the antenna group. Such an approach may be implemented in an example in the center precoding structure or the right-most precoding structure shown in FIG. 4.

The reduction of the choices may be performed through an indicated codebook subset restriction, where the indication may be per antenna group; based on a combined radio resource control (RRC)+MAC-control element (CE), or dynamically indicated by a MAC CE and/or DCI. The restriction may be applied on an antenna group itself, or per precoding choices per antenna group. In another solution, the subset restriction may be determined by the indicated modulation and coding scheme (MCS), where subset restriction may be applied for a lower order modulation.

A WTRU may receive multiple restrictions, then it may receive a dynamic indication of the restriction to be applied for interpretation of the received TPMI. A criterion for application of the subset restriction may be based on some signal quality, for example, power per layer, or power per antenna group. Power per antenna group may be used in an example if a different power rating per antenna group is supported.

A WTRU may determine SRI/TPMI values based on an association, a correlation or both. For example, a WTRU may receive different TPMI codebooks depending on the WTRU reported antenna configuration such as options a and b, or categories a and b, from FIG. 3. Different antenna setups may result in different correlations along vertical or horizontal dimensions. Reusing the same codebook elements and size for every antenna group index (AGI) may result in excessive signaling overhead because the bitfield for TPMIs may cover the entire precoding codebook while there may only be a suboptimal subset of TPMIs for a pair of AGIs.

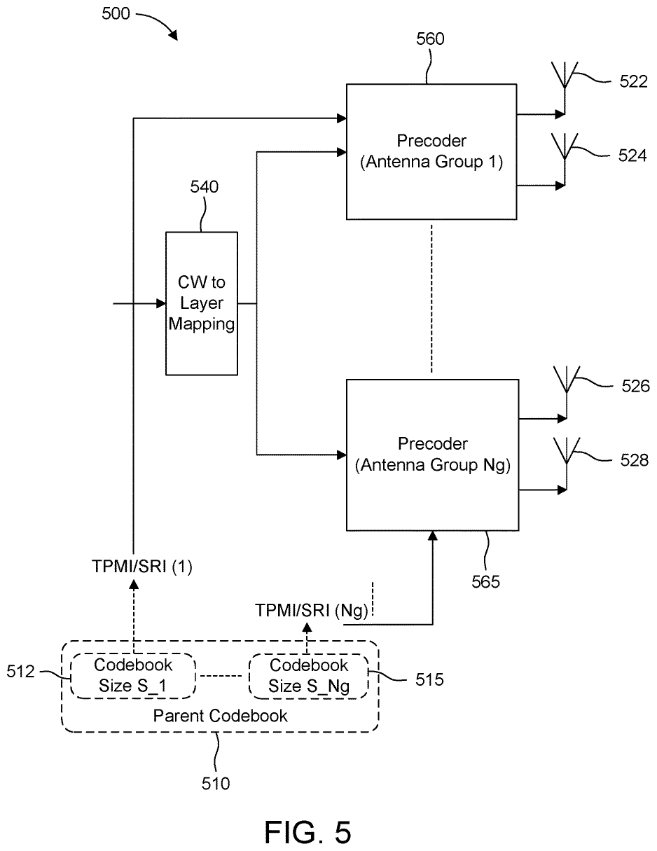

FIG. 5 is a system diagram illustrating an example of mapping of a TPMI indication as a function of the AGI. In an example solution shown in system diagram 500, a WTRU may determine the mapping of a TPMI indication to a codebook of precoders as a function of the AGI. A parent codebook may be defined of size S_0 510 which contains a complete set of precoders, and subsets of the parent codebook 510 may be configured as a function of the AGI. For example, a WTRU may report its supported number of antenna port groups, Ng, as part of its WTRU capability. A WTRU may receive a codebook configuration with Ng codebook subsets, where the first codebook subset is of size S_1 512, the second codebook subset is of size S_2, etc. . . . , and the Ng-th codebook subset is of size S_Ng 515. Each codebook subset may be defined as a subset of precoders from the parent codebook S_0 510.

Also, in an example shown in FIG. 4, module 540 performs CW to layer mapping on data for a CW. Further, the output of module 540 may then be used as input for two precoders 560, 565. Precoder 560 may apply a first received TPMI indication, a first received SRI indication or both to the CW. Further, precoder 565 may apply another received TPMI indication, another received SRI indication or both to the CW. The another received TPMI indication may be the last in a set of Ng TPMI indications received, and applied, by the WTRU. Further, the another received SRI indication may be the last in a set of Ng SRI indications received, and applied, by the WTRU. The CW from precoder 560 may then be transmitted by antennas 522, 524. Also, Also, the CW from precoder 565 may then be transmitted by antennas 526, 528. In an example, antennas 522, 524, 526, 528, may transmit signals to a base station, such as for example, the base station 114a over the air interface 116 shown in FIG. 1A.

A WTRU may also be configured with an association between a codebook subset and an antenna port group. For example, AGI 1 may be associated with the first codebook subset of size S_1 512. A WTRU may receive TPMI for AGI 1 and may determine to use one out of S_1 precoders from the codebook over the antenna ports comprising AGI 1. A WTRU may determine similarly the precoders for the other AGIs. When a WTRU receives an UL grant which may indicate Ng TPMIs, the WTRU may determine the precoder for each AGI by using the respective codebook per AGI. The WTRU may then transmit the physical uplink shared channel (PUSCH) using the selected precoders per AGI. A WTRU may receive a MAC-CE or RRC signaling to reconfigure the associated subset of precoders per AGI for example, the contents of S_i.

If all codebook sizes are equal, then a WTRU may receive Ng TPMIs with the same number of bits per TPMI. In an example of all codebook sizes being equal, S_i=S for all i. In an example solution, even if all codebook sizes are equal, such as S_i=S for all i, the selection available in each codebook may be different.

In an example solution, the Ng TPMI subsets may be configured with a hierarchical structure such as S_1> S_2> . . . >S_g, to achieve different number of bits per TPMI. The configuration may be determined as a function of the WTRU's AGI structure. For example, TPMI1=i_1 may indicate a first precoder from S_1 codebook 512 for AGI 1. For TPMI2, a WTRU may determine the codebook of size S_2 based on a subset of precoders from S_0 510 that is conditioned on TPMI1. For example, indices j_1, . . . j_S2 from S_0 510 are selected if TPMI1=i_1 is indicated. If TPMI1=i_2, a different subset of indices may be taken from S_0 to form the codebook for TPMI2. Similar conditional constructions for the other AGI may be devised. A WTRU may receive a MAC-CE or RRC signaling to reconfigure the associated set of precoders between S_i's.

In some example solutions, a WTRU may receive a preconfigured association between codebook indices such that a WTRU may determine more than one TPMI for more than one AGI based on a single explicit TPMI indication for a reference AGI. The reference AGI may be indicated by the WTRU in its capability report, or signaled by the network in the preconfigured association. For example, for a WTRU with 2 AGIs, AGI1 may be defined as the reference AG, and the TPMI1 for AGI1 may indicate a precoder from a size S1 codebook. For AGI2, TPMI2 may consist of a single precoding vector taken from a codebook of size S_2=1 associated with TPMI1. WTRU may receive TPMI2 and its association to TPMI1 as a preconfigured set of precoders. If a WTRU receives a grant with TPMI1, then a WTRU may transmit a PUSCH using TPMI1 and the associated TPMI2 over AGI1 and AGI2, respectively, without receiving an explicit TPMI2 in the grant.

Examples and embodiments provided herein may include an enhanced rank indication. Further, examples provided herein may include rank information separate from a TPMI indication. In an example solution, a WTRU may receive K_TPMI indication(s), for example, each corresponding to an antenna group, among the K antenna groups, where each indication may correspond to a different rank for transmission by the corresponding antenna group. In an alternative or an additional solution, a WTRU may receive a first indication, such as by a MAC CE, DCI, another implicit/explicit indication, and the like, to determine the transmission rank. Then the WTRU may determine only the precoding information from a received indicated TPMI. Once the WTRU determines the indicated rank, it may identify the preferred precoding and apply the precoding for an uplink transmission. One or more of following further examples may also apply, accordingly. In an example, the WTRU may use the indicated rank to determine the number of layers to use for transmission.

In an exemplary solution, in industrial and FWA applications for example, where some of transmission-related information may vary slowly over time, a WTRU may receive DCI for the first indication where the received DCI may carry, for example, transmission rank or SRI. In an example solution, common DCI may be used to indicate such information for several WTRUs.

In another example solution, the rank information may be determined by using a rank-related radio network identifier (RNTI) used for scrambling of the cyclic redundancy check (CRC) of the DCI carrying the TPMI/SRI information. Using a first indication, a WTRU may determine the transmission rank for the entirety of transmission by the M_TX antenna set or may determine that the transmission rank be per antenna group.

In a further example solution, a WTRU may receive K DCI messages where each DCI message may carry at least one of rank, TPMI and/or SRI indications for an uplink transmission. A WTRU may determine the association of each DCI message to an antenna group based on one or more of following: from an index carried in the DCI message; according to their resource mapping-related information, for example, a physical downlink control channel (PDCCH) mapping order; or an RNTI used for scrambling of the CRC of the DCI message, for example, an AntennaGroup-RNTI.

In yet another example solution, a WTRU may determine a set of applicable TPMI indexes being mapped to a TPMI field in DCI, based on the indicated rank (L) being received for an, for example, per, antenna group. In an example, the set of applicable TPMI indexes may be applicable per corresponding antenna group. In a further example, the TPMI field may include a “precoding information and number of layers” field.

The set of applicable TPMI indexes may comprise one or more TPMI indexes corresponding to rank L, rank f₁(L), rank f₂(L), . . . , rank f_{b}(L), . . . and rank f_{B}(L), where f_{b}(L) is a rank value based on a b-th pre-defined or pre-configured function (with respect to L). In an example, corresponding to may be considered to be one or more of associated with, based on, related to or mapped to. In an example, at least one of f₁(L), rank f₂(L), . . . and rank T_{B}(L) may be configured or associated with a value of L. An independent value of B may be associated with each L. In an example, associate may be considered to be used, configured or both.

In an example, the WTRU may receive a pre-configured, or indicated, mapping table. The mapping table may include an indicated rank, represented by L. Further, the mapping table may include the number of ranks for the set of applicable TPMI indexes, represented by B.

An example of a pre-configured, or indicated, mapping table among L, B, f_{b}(L) is shown in Table 1. Based on Table 1, the WTRU may determine, in response to receiving the indicated rank (L), which value of B is applied. Based on the value of B, the WTRU may determine that the set of applicable TPMI indexes May comprise one or more TPMI indexes that correspond to or are associated with at least one of rank f₁(L), . . . , rank f_{B}(L). In an example, the one or more TPMI indexes may be from a parent TPMI-related table, from the parent codebook, and/or from the (whole) applicable rows of the ‘Precoding information and number of layers’ field mapping table, which may be also according to the coherency parameter. This may provide benefits in terms of signaling overhead reduction with respect to the DCI field size which may be a critical factor of the reliability of a control channel, via which the DCI may be transmitted.

TABLE 1

| | | rank | rank | rank | rank |
|---|---|---|---|---|---|
| | B | f₁(L) | f₂(L) | f₃(L) | f₄(L) |
| L = 1 | 1 | rank 1 | | | |
| L = 2 | 2 | rank 1 | rank 2 | | |
| L = 3 | 3 | rank 1 | rank 2 | rank 3 | |
| L = 4 | 4 | rank 1 | rank 2 | rank 3 | rank 4 |
| L = 5 | 4 | rank 1 | rank 2 | rank 3 | rank 5 |
| L = 6 | 4 | rank 1 | rank 3 | rank 5 | rank 6 |
| L = 7 | 4 | rank 1 | rank 3 | rank 5 | rank 7 |
| L = 8 | 4 | rank 1 | rank 4 | rank 6 | rank 8 |

In an example, the WTRU may receive a pre-configured, or indicated, mapping table among L, B, f_{b}(L) as shown in Table 1. The WTRU may receive the indicated rank (L) set to L=3, for example, for a first antenna group. In response to receiving the indicated rank of L=3, the WTRU may determine a value of B is 3 based on the Table 1. In response to determining that B is 3, the WTRU may determine the set of applicable TPMI indexes by removing/excluding one or more rows, for TPMI indexes, not corresponding to rank f₁(3) (which is rank 1 from the Table 1), rank f₂(3) (which is rank 2 from the Table 1), and rank f_{B=3}(3) (which is rank 3 from the Table 1), as shown by the strikethrough marks in Table 2, below.

Table 2 is an example of determining the set of applicable TPMI indexes from a parent table/codebook. The rest of the rows in Table 2, being not removed/excluded, may be re-indexed, for example, from TPMI index=0, to result in a low-overhead TPMI field construction with lowered TPMI field bitwidth/size. This is one example based on an example parent codebook with a coherency-related parameter set to ‘fullyAndPartialAndNonCoherent’ and a max rank up to 4. An example parent codebook may be based on a different coherency-related parameter set to ‘partialAndNonCoherent’ or other applicable value, and/or based on a different max rank, for example, up to 8, and the like, where the proposed WTRU behaviours at least for determining the set of applicable TPMI indexes may be applied for a configured, generated, parent codebook.

TABLE 2

| Bit field | |
|---|---|
| mapped | |
| to index | codebookSubset = fullyAndPartialAndNonCoherent |
| 0 | 1 layer: TPMI=0 |
| 1 | 1 layer: TPMI=1 |
| . . . | . . . |
| 3 | 1 layer: TPMI=3 |
| 4 | 2 layers: TPMI=0 |
| . . . | . . . |
| 9 | 2 layers: TPMI=5 |
| 10 | 3 layers: TPMI=0 |
| [symbol] | [symbol] |
| 12 | 1 layer: TPMI=4 |
| . . . | . . . |
| 19 | 1 layer: TPMI=11 |
| 20 | 2 layers: TPMI=6 |
| . . . | . . . |
| 27 | 2 layers: TPMI=13 |
| 28 | 3 layers: TPMI=1 |
| 29 | 3 layers: TPMI=2 |
| [symbol] | [symbol] |
| [symbol] | [symbol] |
| 32 | 1 layers: TPMI=12 |
| . . . | . . . |
| 47 | 1 layers: TPMI=27 |
| 48 | 2 layers: TPMI=14 |
| . . . | . . . |
| 55 | 2 layers: TPMI=21 |
| 56 | 3 layers: TPMI=3 |
| . . . | . . . |
| 59 | 3 layers: TPMI=6 |
| [symbol] | [symbol] |
| [symbol] | [symbol] |
| . . . | . . . |

In an example, the WTRU may receive a pre-configured, or indicated, mapping table among L, B, f_{b}(L) as shown in Table 1. The WTRU may receive the indicated rank (L) set to L=2, for example, for a second antenna group. In response to receiving the indicated rank of L=2, the WTRU may determine a value of B is 2 based on the Table 1. In response to determining that Bis 2, the WTRU may determine the set of applicable TPMI indexes by removing/excluding one or more rows, for TPMI indexes, not corresponding to rank f₁(2) (which is rank 1 from the Table 1) and rank f_{B=2}(2) (which is rank 2 from the Table 1), as shown by the strikethrough marks in Table 3, below.

Table 3 is an example of determining the set of applicable TPMI indexes from a parent table/codebook. The rest of the rows in Table 3, being not removed/excluded, may be re-indexed, for example, from TPMI index=0, to result in a low-overhead TPMI field construction with lowered TPMI field bitwidth/size. This is one example based on an example parent codebook with a coherency-related parameter set to ‘fullyAndPartialAndNonCoherent’ and a max rank up to 4. An example parent codebook may be based on a different coherency-related parameter set to ‘partialAndNonCoherent’ or other applicable value, and/or based on a different max rank, for example, up to 8, and the like, where the proposed WTRU behaviours at least for determining the set of applicable TPMI indexes may be applied for a configured, or generated, parent codebook.

TABLE 3

| Bit field | |
|---|---|
| mapped | |
| to index | codebookSubset = fullyAndPartialAndNonCoherent |
| 0 | 1 layer: TPMI=0 |
| 1 | 1 layer: TPMI=1 |
| . . . | . . . |
| 3 | 1 layer: TPMI=3 |
| 4 | 2 layers: TPMI=0 |
| . . . | . . . |
| 9 | 2 layers: TPMI=5 |
| [symbol] | [symbol] |
| [symbol] | [symbol] |
| 12 | 1 layer: TPMI=4 |
| . . . | . . . |
| 19 | 1 layer: TPMI=11 |
| 20 | 2 layers: TPMI=6 |
| . . . | . . . |
| 27 | 2 layers: TPMI=13 |
| [symbol] | [symbol] |
| [symbol] | [symbol] |
| [symbol] | [symbol] |
| [symbol] | [symbol] |
| 32 | 1 layers: TPMI=12 |
| . . . | . . . |
| 47 | 1 layers: TPMI=27 |
| 48 | 2 layers: TPMI=14 |
| . . . | . . . |
| 55 | 2 layers: TPMI=21 |
| [symbol] | [symbol] |
| . . . | . . . |
| [symbol] | [symbol] |
| [symbol] | [symbol] |
| [symbol] | [symbol] |
| . . . | . . . |

In an example, the WTRU may receive a scheduling grant, such as via a UL-related DCI, for example, format 0_1, 0_2, comprising at least two TPMI fields. In an example, a first TPMI field may correspond to the first antenna group and may be generated/constructed based on Table 2, above. Further, a second TPMI field may correspond to the second antenna group and may be generated/constructed based on Table 3, above. The WTRU may receive, with the scheduling grant, a first value of the first TPMI field indicating the index 4 as “2 layers: TPMI=0”, and a second value of the second TPMI field indicating the index 3 as “1 layer: TPMI=3”. In response to receiving the values, the WTRU may apply, or for example, generate, a first precoder, for example, a 2-layer precoder based on TPMI=0, on the first antenna group, and a second precoder, for example, a 1-layer precoder based on TPMI=3, on the second antenna group. The WTRU may perform a UL transmission based on using the first precoder for the first antenna group and the second precoder for the second antenna group, which may be transmitted simultaneously, for example, from both the first and second antenna groups, if the WTRU has been configured/indicated to perform such simultaneous transmission from more than one antenna group.

Examples and embodiments herein include an optimized 8 port SRI indication for non-codebook based PUSCH transmission. In an example, when a WTRU is configured with non-codebook PUSCH transmission, it may receive a configuration of an SRS resource set with N_{SRS} single port SRS resources, and Lₘₐₓ maximum number of layers. The WTRU can be scheduled to transmit a PUSCH, and the WTRU may determine the precoder for the PUSCH antenna ports as a function of an SRI indication in a DCI that maps to the SRS resources. The WTRU may receive a DCI with a bit field that dynamically indicates the port indices scheduled for the PUSCH transmission. For example, Table 4 below represents an example of one such table when Lₘₐₓ=2.

TABLE 4

| Bit field | | Bit field | | Bit field | |
|---|---|---|---|---|---|
| mapped to | SRI(s), | mapped | SRI(s), | mapped to | SRI(s), |
| index | N_{SRS} = 2 | to index | N_{SRS} = 3 | index | N_{SRS} = 4 |
| 0 | 0 | 0 | 0 | 0 | 0 |
| 1 | 1 | 1 | 1 | 1 | 1 |
| 2 | 0,1 | 2 | 2 | 2 | 2 |
| 3 | reserved | 3 | 0,1 | 3 | 3 |
| | | 4 | 0,2 | 4 | 0,1 |
| | | 5 | 1,2 | 5 | 0,2 |
| | | 6-7 | reserved | 6 | 0,3 |
| | | | | 7 | 1,2 |
| | | | | 8 | 1,3 |
| | | | | 9 | 2,3 |
| | | | | 10-15 | reserved |

Table 4 is an example of an SRI indication for non-codebook based PUSCH transmission with Lₘₐₓ=2. As seen in Table 4, each row may indicate the SRI port indices which can be 1 or 2 ports since up to a maximum of Lₘₐₓ=2 layers can be scheduled. For a given N_{SRS}, all possible pairs of ports 0 to N_{SRS}−1 can be indicated, and the bit field size in the DCI increases as the number of combinations increases. In general, the number of indices required is

$${N}_{indices} = {\sum }_{i = 1}^{{L}_{m ax}} {C}_{i}^{{N}_{SRS}} where {C}_{k}^{n}$$

is the combinatorial coefficient (n choose k), and the number of bits required is the smallest power of 2 greater than N_{indices}.

In recent wireless communications specifications, the maximum N_{SRS} is 4. If the same design principle is reused for up to N_{SRS}=8 considered in current specifications discussions, all existing tables need to be redesigned which may require a large number of rows, and significant specification impact. For example, for N_{SRS}=8 and Lₘₐₓ=8, a table with 255 possible indices is needed with an 8 bit field. Accordingly, in the following examples, solutions are proposed to minimize the wireless communications specification impact of the SRI indication and increase efficiency in wireless communications.

In examples, the WTRU may receive concatenated bit fields corresponding to activated antenna ports. In an example solution, a WTRU configured with non-codebook PUSCH transmission may determine the indicated N_{SRS} SRS ports using the indication mechanism employed for N_{SRS}/2 SRS ports. In a solution, when N_{SRS} is greater than a threshold, such as, for example, 4, a WTRU configured with non-codebook PUSCH transmission may determine the indicated SRS ports by using the indication mechanism used for N_{SRS}/2 SRS ports indication by using one of or any combination of the following. The WTRU may use two concatenated SRI fields for indication of

$${N}_{SRS}^{1} and {N}_{SRS}^{2}$$

ports, where the sum of equals

$${N}_{SRS}^{i}$$

equals to N_{SRS}, and

$${N}_{SRS}^{i} \leq {N}_{SRS} / 2.$$

Further, the WTRU may use a port mapping table for indication of up to

$$\frac{{N}_{S RS}}{2}$$

SRS ports, for example. Also, the WTRU may use Table 4 to determine the indicated SRS ports.

In an exemplary solution, a WTRU may receive a first and a second SRI. The WTRU may map the first received SRI index to Table 4 to determine the first set of indicated ports. Then, the WTRU may map the second received SRI index to Table 4, and may add one or more offset values (N_{SRS}/2) to the values of indicated ports from Table 4. In an alternative solution or an additional solution, the offset value may be configurable, and may be indicated to the WTRU.

For example, for N_{SRS}=8, two SRI indications with

$${N}_{SRS}^{i} = 4$$

ports may be used. Each row of Table 4 may be indexed with up to 4 bits as shown in the last two columns of Table 4. The WTRU may receive DCI with two bit fields where each bit field maps to the index in the table. The WTRU may receive a first index of 4 indicating {0,1}, and a second index of 9 indicating {2,3}. The WTRU may map the first index to the first set of 4 ports, so ports 0 and 1 are identified. Then, the WTRU may map the second index to the second set of 4 ports by adding a shift of

$${N}_{SRS}^{1}$$

to the indication, so that ports {2,3}+4={6,7} are identified. Then, the WTRU may determine the SRS ports {0,1,6,7} for non-codebook based PUSCH transmission.

If a reserved field is indicated, the WTRU may determine that the ports are not mapped. For example, if the first bit field indicates 10 instead of 4, then the WTRU may determine that the first bit field indicates ‘Reserved’ and ports {0,1,2,3} are not identified, and only SRS ports {6,7} are identified.

If both indices map to reserved fields, a WTRU may determine to transmit according to a predetermined behavior. For example, a WTRU may precode the PUSCH according to a default precoder that is preconfigured. In an example, the default precoder may be one TPMI from the codebook.

In some example solutions, a WTRU may receive a single SRI indication of N_{SRS} ports, and maps it to 2*N_{SRS} ports by applying the received indication to the first N_{SRS} ports, and implicitly determine the indication for the next N_{SRS} ports by applying the shift of N_{SRS}. For example, with N_{SRS}=4 and Lₘₐₓ=4, the WTRU may receive an index of 4 indicating {0,1}. The WTRU may determine that antenna ports {0,1,4,5} are identified.

In an example solution, the Table may be configured by RRC signaling. The configuration may be based on the number of antenna groups.

Examples and embodiments herein include enhanced precoding structures. Further, examples are provided herein of antenna group selection and precoding structure. For an uplink transmission, a WTRU may partition an M-TX antenna set to K antenna groups comprising of N TX antennas per antenna group, where N≤M. It may be further assumed that the antennas within each antenna group are coherent. For the brevity of presentation of the main idea, it is assumed that each antenna group has a same number of TX antennas, however the same presented solutions below may be applied for the cases where antenna groups have a different number of TX antennas.

In an example solution, an uplink precoder structure may be constructed based on a W=FW1W2W3 structure. F may be used to select a subset of antenna groups, hence, to select all antenna groups, F=I, where I is the identity matrix. The selection of F may be based on a preferred WTRU directional transmission, coherence capability of the WTRU, and the like.

W1 may contain all the preferred beam bases for precoding. W1 may be defined for the entire set of M TX antennas at a WTRU, or for subset of antenna groups, or alternatively per antenna group. The set of beam basis may be fixed or preconfigured. Alternatively or additionally, for a given deployment scenario, a set of beam basis may be determined based on some measurements, for example, using sounding reference signals to form W1. When W1=I, no specific beam basis may be selected.

W2 may contain coefficients for beam selection and/or combining. W2 may be defined for the entire set of M TX antennas at a WTRU, or for subset of antenna groups, or alternatively per antenna group.

W3 may contain phase coefficients for co-phasing between different antenna groups. In a solution, the application of W3 may be determined based on WTRU coherence capability.

An uplink precoder may be constructed with a subset of component precoders (F, W1, W2, W3). For example, a first uplink precoder may be constructed with W1 and W2. Accordingly, the first uplink precoder may be shown by, W=W1W2, in an example. Further, a second uplink precoder may be constructed with F, W1, and W2. As a result, a second uplink precoder may be shown by, W=FW1W2, in an example.

A WTRU may perform one or more of the following steps for determination of component precoders, such as one or more of F, W1, W2, or W3, for an uplink transmission. A determination of F for selection of one or more of K antenna groups for transmission may include one or more of the following steps. In an example solution, a WTRU may be configured with K SRS resource sets where each SRS resource set contains an SRS resource with N TX ports. Alternatively or additionally, a WTRU may be configured with one SRS resource set containing K SRS resources each with N TX ports.

Using the configured K SRS resources, a WTRU may perform K SRS transmissions where the K transmitted SRS may or may not be precoded. In an example solution, upon completion of the transmission, a WTRU may receive an implicit or an explicit indication from a base station to identify the preferred L antenna groups for uplink transmission. In an example, the base station may be a gNB. In an example solution, a WTRU may receive L≤K SRI indications to determine the preferred L antenna groups for uplink transmission. Additionally or alternatively, a WTRU may receive a length-K bitmap or codeword to determine the preferred L antenna groups for uplink transmission.

Examples provided herein include identifying basis vectors. In an example solution, a WTRU may determine the component precoder W1 based on an SRI received from a gNB or base station, wherein the SRI may be associated with a pre-coded SRS resource. For example, a WTRU may determine one or more W1 candidate matrices based on measurement of a downlink reference signal and pre-code one or more SRS resources with determined W1 candidate matrices. In an example, the downlink reference signal may be a non-zero power (NZP)-channel state information (CSI)-reference signal (RS). Then, the WTRU may send the one or more SRS resources, and may receive SRI which may indicate at least one of SRS resources sent by the WTRU. The WTRU may determine W1 based on the received SRI. For example, the WTRU may use the same W1 which is used to pre-code the indicated SRS resource. One or more of following may apply.

The number of SRS ports in an SRS resource may be the same as the number of beams in W1 matrix, which may be shown in the number of columns in W1, in an example. The number of SRS ports in an SRS resource may be determined based on a configuration of a W2 matrix. For example, if a 4 Tx codebook is used for W2, the number of SRS ports in an SRS resource may be 4. Similarly, if a 2 Tx codebook is used for W2, the number of SRS ports in an SRS resource may be 2. The W1 candidate matrices may be up to WTRU implementation. The total number of W1 candidate matrices may be indicated as a WTRU capability. Alternatively or additionally, a WTRU may indicate a required number of SRS resources for W1 selection. For example, if a WTRU determines N candidate matrices for W1, the WTRU may indicate to a base station that N SRS resources are needed for W1 determination. In an example, the base station may be a gNB. The total number of W1 candidate matrices may be configured by the gNB or base station. For example, a gNB or base station may configure the number of SRS resources for W1 determination and a WTRU may determine W1 candidate matrices based on the number of SRS resources configured.

In another example solution, a WTRU may determine the component precoder W1 based on one or more SRIs received from a gNB or base station, wherein each SRI may be associated with an SRS resource comprising a single SRS port, for example, a single port SRS resource. For example, a WTRU may determine a set of beams, for example, N precoding vectors, and each beam, for example, precoding vector, may be pre-coded to an SRS resource. The WTRU may receive indication of a subset of beams which may be one or more SRIs associated with single port SRS resources pre-coded with the set of beams. In an example, the indication of a subset of beams may be an indication of M precoding vectors, where M is less than or equal to N.

Each SRI may determine a beam of a W1 matrix, for example, a column vector of W1 matrix. Therefore, if N beams are used for the W1 matrix, N SRIs may be indicated to a WTRU. The number of SRIs may be determined based on the number of beams in the W1 matrix, for example, the number of columns in W1. A WTRU may determine W1 based on the set of SRIs indicated or determined. The number of SRIs may be determined based on a configuration of a W2 matrix. For example, if a 4Tx codebook is used for W2, the number of SRIs may be 4. Similarly, if a 2 Tx codebook is used for W2, the number of SRIs may be 2.

In an additional or alternative solution, a WTRU may be configured with more than one single port SRS resources. For example, a WTRU may be configured with LxN, KxN, M single port SRS resources. The configured SRS resources may be configured within the same SRS resource sets or spread over the K SRS resources according to the number of antennas per antenna group. In an example solution, using the configured single port SRS resources, a WTRU may transmit P SRSs where each may be beamformed with a different spatial filter.

Upon transmission of the P SRSs, a WTRU may receive an indication to determine a P_basis preferred subset of beams for construction of the W1. In an example solution, a WTRU may receive one or more SRIs to determine the basis beams for formation of the W1 matrix. To indicate the preferred set of one or more basis beams, semi-static, dynamic or a combination thereof may be used. In an exemplary solution, a dynamic signaling, for example, a MAC CE or DCI may indicate the preferred P_basis for construction of the W1. In another example solution, more than P_basis preferred beams may be configured semi-statically, and then a dynamic signaling, for example, a MAC CE or DCI, may indicate the preferred P_basis from the configured list.

In an example solution, a WTRU may determine the component precoder W2 based on a TPMI indication in the DCI scheduling uplink grant. One or more of following may apply. W2 may be used to combining beams in W1 for each layer for PUSCH transmission, wherein the combining may be performed with power scaling and phase rotation of one or more beams in W1. One or more codebooks may be used for W2 and a WTRU may receive an indication of codebook to use.

In another example solution, a WTRU may determine the component precoder W2 based on channel measurement of downlink, for example, NZP-CSI-RS, when channel reciprocity holds between uplink and downlink. One or more of following may apply. The W2 may be determined by a WTRU based on a given W1, or FW1, which may be indicated by the base station. In an example, the base station may be a gNB.

In an example solution, one or more antenna groups may be used, may be configured, or both. Further, each antenna group may be associated with a composite precoder, for example, FW1W2. In an example, the number of antenna ports is the same across antenna groups and a WTRU may determine a common composite precoder, for example, FW1W2, and the WTRU may determine a co-phasing precoder, for example, W3, for co-phasing between different antenna groups. One or more of the following may apply. A codebook may be used for W3, wherein the codebook may be predefined, configured, or reported and known between a transmitter, for example, a WTRU, and a receiver, for example, a base station. In an example, the base station may be a gNB. A TPMI may be indicated for W3, for example, with separate one or more TPMIs for other component precoders, in the DCI scheduling uplink, for example, a PUSCH transmission.

Examples provided herein include codeword to layer and antenna group mapping. In an example solution, for transmission with two codewords, an 8 Tx WTRU may use the following codeword to layer mapping for its uplink transmission, as shown in Table 5.

TABLE 5

| | | Codeword-to-layer mapping |
|---|---|---|
| Number of layers | Number of codewords | $i = 0 , 1 , … , {M}_{symb}^{layer} - 1$ |
| 5 | 2 | CW1 mapped to layer 1 and 2 |
| | | CW2 mapped to layer 3, 4 and 5 |
| 6 | 2 | CW1 mapped to layer 1, 2 and 3 |
| | | CW2 mapped to layer 4, 5 and 6 |
| 7 | 2 | CW1 mapped to layer 1, 2 and 3 |
| | | CW2 mapped to layer 4, 5, 6 and 7 |
| 8 | 2 | CW1 mapped to layer 1, 2, 3 and 4 |
| | | CW2 mapped to layer 5, 6, 7 and 8 |

Table 5 is an example of a codeword to layer and antenna group mapping. In examples related to the above Table 5, the number of layers may be the same as the transmission rank. Further, a WTRU with more than one antenna group, for example, Ng=2, may support following cases of layer split for rank R=5 and R=6, as shown in the following in Table 6. Table 6 is an example of layers in one antenna group and in layers split across two antenna groups.

TABLE 6

| | All layers in one | Layers split across |
|---|---|---|
| Rank | Antenna Group | two Antenna Groups |
| 1 | (1,0), (0,1) | — |
| 2 | (2,0), (0,2) | — |
| 2 | — | (1,1) |
| 3 | (3,0), (0,3) | — |
| 3 | — | (1,2), (2,1) |
| 4 | (4,0), (0,4) | — |
| 4 | — | (2,2) |
| 5 | — | (2,3), (3,2) |
| 6 | — | (3,3) |
| 7 | — | (3,4), (4,3) |
| 8 | — | (4,4) |

In an example solution, a WTRU may extend the principle of the codeword to layer mapping for layer to antenna group mapping. Therefore, a WTRU may not use more than one antenna group for transmission of the layers of a same codeword.

In an exemplary solution, for transmission with rank R=5, if the indicated layer split across the antenna group is (2, 3), then the first two layers corresponding to the first codeword may be mapped on the first antenna group, and the second three layers that are corresponding to the second codeword may be mapped to the second antenna group. However, when the indicated layer split across the antenna group is (3, 2), then then the first three layers corresponding to the second codeword may be mapped on the first antenna group, and the second two layers that are corresponding to the first codeword may be mapped to the second antenna group.

Similarly, in another exemplary solution, for transmission with rank R=7, if the indicated layer split across the antenna group is (3, 4), then the first three layers corresponding to the first codeword may be mapped on the first antenna group, and the second four layers that are corresponding to the second codeword may be mapped to the second antenna group. However, when the indicated layer split across the antenna group is (4, 3), then then the first four layers corresponding to the second codeword may be mapped on the first antenna group, and the second three layers that are corresponding to the first codeword may be mapped to the second antenna group.

In an example solution, a WTRU with Ng=4 antenna group may assume every two antennas operate as a pair and employ a similar principle as used for Ng=2 for layer splitting over the antenna groups. In a solution, a WTRU may support the following modes of transmission, as shown in Table 7. Table 7 is an example of layers split across four antenna groups.

TABLE 7

| | All layers | |
|---|---|---|
| | in one | |
| | Antenna | Layers split across four Antenna Groups |
| Rank | Group | (All possible permutations) |
| 3 | — | To imitate (3, 0) as in Ng=2: (2,1,0,0), (1,2,0,0) |
| | | To imitate (0, 3): (0,0,2,1), (0,0,1,2) |
| | | To imitate (2, 1) as in Ng=2: (2,0,1,0), (2,0,0,1), |
| | | (0,2,1,0), (0,2,0,1) |
| | | To imitate (1, 2) as in Ng=2: (1,0,2,0), (1,0,0,2), |
| | | (0,1,2,0), (0,1,0,2) |
| 5 | — | To imitate (2, 3) as in Ng=2: (2,0,2,1), (2,0,1,2), |
| | | (0,2,2,1), (0,2,1,2) |
| | | To imitate (3, 2) as in Ng=2: (2,1,2,0), (2,1,0,2), |
| | | (1,2,2,0), (1,2,0,2) |
| 6 | — | To imitate (3, 3) as in Ng=2: (2,1,2,1), (1,2,1,2), |
| | | (1,2,2,1), (2,1,1,2) |
| 7 | — | To imitate (3, 4) as in Ng=2: (2,1,2,2), (1,2,2,2) |
| | | To imitate (4, 3) as in Ng=2: (2,2,2,1), (2,2,1,2) |

In an example solution, by relying on pairing of every two antenna groups, an 8 Tx WTRU, with Ng=4, may apply the same principle of the codeword to layer mapping for layer to antenna group mapping as used for Ng=2. Therefore, a WTRU may not use more than one antenna group for transmission of the layers of a same codeword.

An 8 Tx WTRU may transmit more than one codeword only when the rank R>4, otherwise a single codeword is transmitted. To support dual codeword PUSCH transmission, an 8 Tx WTRU may receive an additional set of indications for the second codeword, that may include a second MCS field with a size of, for example, 5 bits, a second new data indicator (NDI) field (1 bit) and a second redundancy version (RV) field with a size of, for example, 2 bits. If in the received scheduling DCI, the indicated rank is R≤4, the WTRU may use and interpret one or more the DCI fields related to transmission of the second codewords for other purposes.

In an example solution, a WTRU may have a much larger number of precoders for transmission for R≤4 than transmission with R>4. In an example solution, a WTRU may use and interpret one or more of the DCI fields related to transmission of the second codewords for determination of TPMI. For example, if R>4 and both a first codeword and a second codeword are to be transmitted, then the DCI fields may carry information regarding both codewords. However, if R≤4 and only a first codeword is to be transmitted, then the DCI fields may carry information regarding only the first codeword. The WTRU may, therefore, use the DCI fields that would otherwise be used to carry information regarding the second codeword to instead enhance precoder resolution for the first codeword. As a result, the WTRU may employ improved wireless communications.

A WTRU may use the additional information for enhancing the precoder resolution in one or more of the following manners. For example, a WTRU may use the additional indication for determination of a precoder that may be associated with the same codebook. For example, using the same principle, for example, DFT-based codebook, a codebook, may be generated where it may have N1 precoders for R=1, N2 precoders for R=2, N3 precoders for R=3, N4 precoders for R=4, and have N5 precoders for R=5, N6 precoders for R=6, N7 precoders for R=7, N8 precoders for R=8, where N1+N2+N3+N4>N5+N6+N7+N8.

Additionally or alternatively, the WTRU may use the additional information for determination of a precoder from a different codebook. For example, according to one or more information elements in part of the indications related to the second codeword, a WTRU may interpret the indicated TPMI by using a different codebook. For example, in a solution, if NDI allocated for the second codeword is zero, a WTRU may interpret the indicated TPMI according to a design based on an existing DL codebook, and when NDI for the second codeword is one, WTRU may interpret the indicated TPMI according to a design based on an existing UL codebook. In an example, the DL codebook may be an NR DL codebook and the UL codebook may be an NR UL codebook.

In another example solution, the additional information may be used to enhanced the indicated TPMI by indicating a second precoder to be applied on the indicated precoder. The enhancing may be performed by a introducing a co-phasing operation, a cascaded precoder, a Kronecker co-matrix, and the like.

In an example solution, when R≤4, a WTRU may determine whether to use the additional indication related to the second codeword using one or more of the following. In an example solution, to determine whether to use the additional indication, a WTRU may use a dynamic indication, for example, a DCI or a MAC CE. In another example solution, a WTRU may perform such determination based on a specific indication in the scheduling DCI, for example, one or more NDI bits associated with the second codeword, a specific RV value associated with the second codeword, and the like. In an additional solution or an alternative solution, a WTRU may perform the determination based on a reserved codepoint or a specific indicated TPMI. For example, when TPMI=x, then the WTRU may use one or more of the DCI fields associated with the second codeword to enhance precoder resolution.

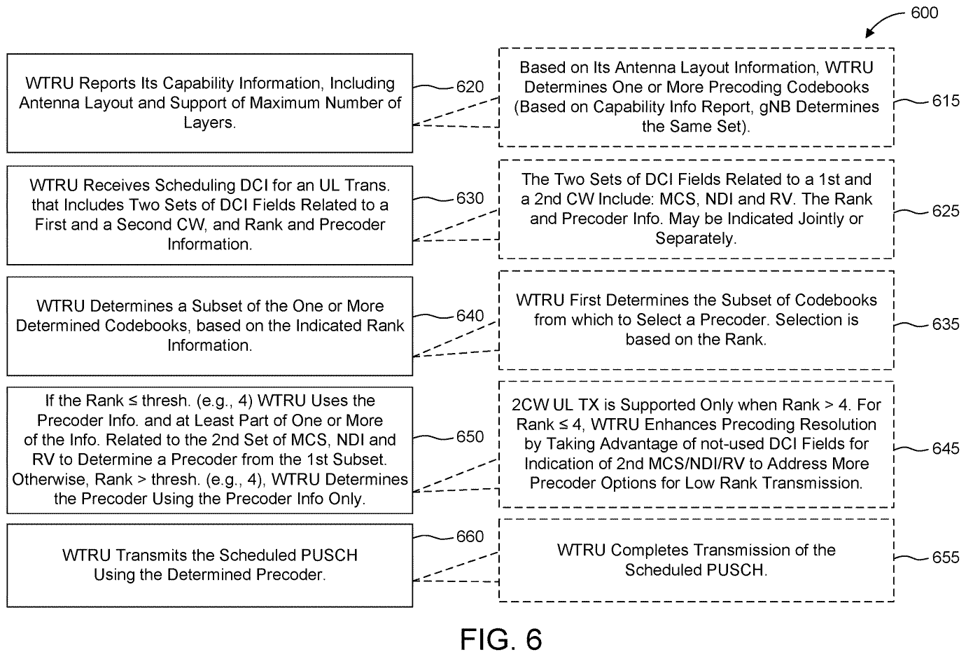

FIG. 6 is a flowchart diagram illustrating an example of codebook subset selection and support of high resolution uplink precoding. In an example shown in flowchart diagram 600, a WTRU may report its capability information, including antenna layout and support of maximum number of layers 620. In an example, the WTRU may report this information to a base station. The base station may be a gNB, in an example. In a further example, the WTRU may determine, based on its antenna layout information, one or more precoding codebooks. For example, the WTRU may determine a set of precoding codebooks 615. Also, based on the information in the capability information report received by the base station, the base station may determine the same set of precoding codebooks at the set determined by the WTRU.

In a further example, the WTRU may receive scheduling DCI for an uplink transmission 630. The scheduling DCI may include two sets of DCI fields related to a first codeword and a second codeword, and may include rank information and precoder information. In a further example, the two sets of DCI fields related to the first codeword and the second codeword include MCS, NDI and RV information 625. Further, the rank information and precoder information for the uplink transmission may be indicated to the WTRU jointly or separately.

In addition, the WTRU may determine a subset of the one or more determined precoding codebooks based on the indicated rank formation 640. In an example, the WTRU may determine the subset of precoding codebooks in order to select a precoder 635. In an example, the determined subset of precoding codebooks may be a first subset of precoding codebooks. The selection of the precoder may be based on rank, as explained further herein.

In an example, if the rank is less than a threshold, the WTRU may use the precoder information, and at least part of one or more of the information related to the second set of MCS, NDI and RV, to determine a precoder from the first subset of precoding codebooks 650. In an example, the threshold may be four. If the rank is above the threshold, the WTRU may determine the precoder using the received precoder information only. In an example, a second codeword for use in uplink transmission is supported only when a rank is greater than a threshold, such as four 645. For a rank less than a threshold, such as four, the WTRU may enhance precoding resolution by taking advantage of the not-used DCI fields for indication of one or more of a second MCS, a second NDI, or a second RV. In this way, the WTRU may address more precoder options for low rank transmission.

Also, the WTRU may transmit the scheduled PUSCH using the determined precoder 660. In this way, the WTRU may complete transmission of the scheduled PUSCH 655.

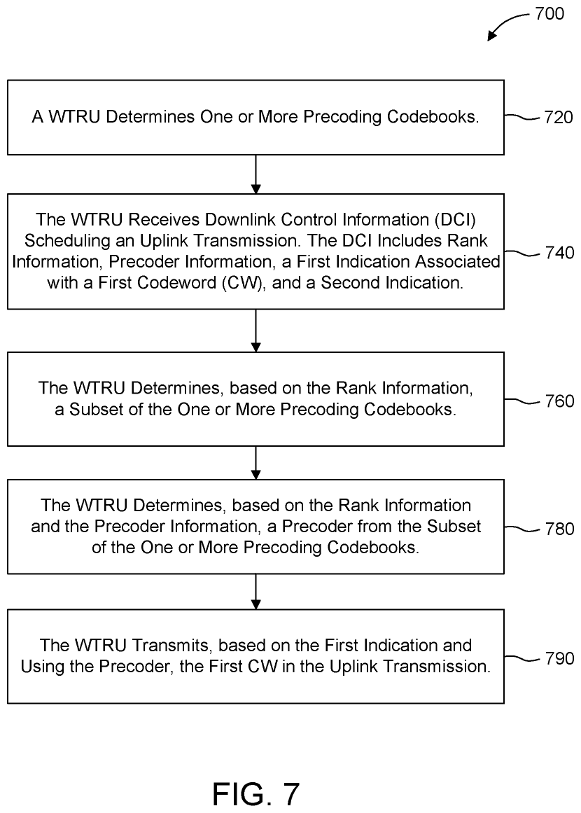

FIG. 7 is a flowchart diagram illustrating another example of codebook subset selection. In an example shown in flowchart diagram 700, a WTRU may determine or more precoding codebooks 720. Further, the WTRU may receive DCI scheduling an uplink transmission 740. In an example, the DCI may include rank information, precoder information, a first indication associated with a first CW, and a second indication. The WTRU may determine, based on the rank information, a subset of one or more precoding codebooks 760. Also, the WTRU may determine, based on the rank information and the precoder information, a precoder from the subset of the one or more precoding codebooks 780. Additionally, the WTRU may transmit, based on the first information and using the precoder, the first CW in the uplink transmission 790.

In an additional example, the second indication may be associated with the second CW. In another example, the second indication may be associated with precoder selection.

In a further example, the WTRU may determine, on a condition that the rank information indicates that the rank is less than or equal to a threshold value, the precoder from the subset of the one or more precoding codebooks, based on the precoder information and at least part of the second indication. In an example, the threshold value may be four (4).

In another example, the second indication may be associated with precoder selection, on a condition that the rank information indicates that the rank is less than or equal to the threshold value. In a further example, the second indication may be associated with the second CW, on a condition that the rank information indicates that the rank greater than the threshold value.

Further, the WTRU may transmit, based on the second indication, the second codeword using the precoder information. In an example, the second indication may indicate an MCS. In another example, the second indication may indicate an RV. In a further example, the second indication may indicate whether new data is to be transmitted.

For a WTRU employing the precoding structure W=FW1W2W3, one or more of the following modes of operation can be considered. F may be considered to use for selection of one or more of the antenna groups. In an example solution, a WTRU may assume F such that at least one row is to contain all zero elements to select a limited set of antenna groups for an uplink transmission. For example, in an exemplary solution, a WTRU may have an antenna layout comprised of four antenna groups where each antenna group is pointed to a different direction, for example, spanned by 90 degrees. Then, the WTRU may select only a subset of the antenna groups for its uplink transmission.

In an example solution, a WTRU may determine the assumption of W1 based on its coherent capability.

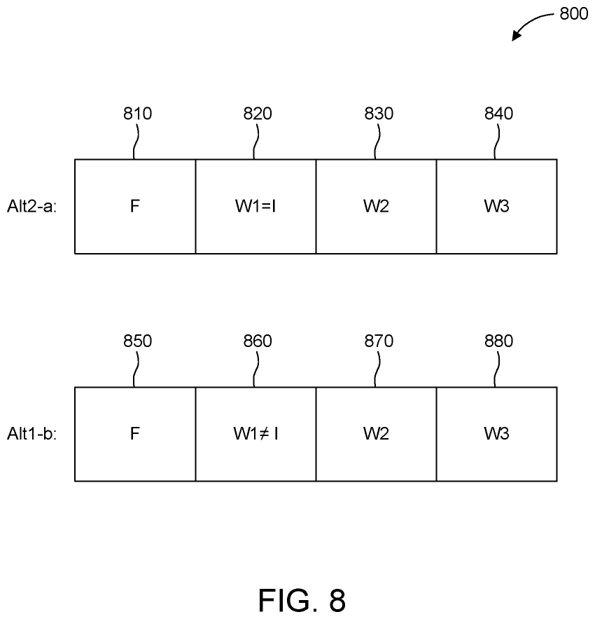

FIG. 8 is a system diagram illustrating an example of a general precoding structure. In an example solution shown in system diagram 800, in Alt1-b, a fully coherent WTRU may assume W1≠1 860, hence W1 may contain the preferred basis vectors for precoded transmission. As described earlier, W1 may be fixed or may be determined based on channel sounding. Further, a partial-coherent WTRU may also assume W1/1, where W2 870 may be determined per antenna group, and W3 880 may also be used for co-phasing. As shown in FIG. 8, F 850 may be positioned at the head of the precoding structure.

In an alternative or additional solution shown in FIG. 8 in Alt2-a, a non-coherent WTRU may assume that W1=1 820, hence W2 830 may contain the information for antenna selection and/or combining. Further, a partial-coherent WTRU may also assume W1=1 820, where W2 830 may be determined per antenna group, and W3 840 may also be used for co-phasing. As in the example in Alt1-b, in Alt2-a, F 810 may be positioned at the head of the precoding structure.

Examples provided herein include enhancements for a DL Type I codebook for uplink usage. The general codebook structure for downlink transmission has been defined by the structure W=W1W2 where precoding operators W1 and W2 are indicated by indices i1 and i2. The index i1 is a composite index that selects DFT vectors corresponding to the strongest beams, and is defined as.

$${i}_{1 =} : \{ \begin{matrix}[ \begin{matrix}{i}_{1 , 1} & {i}_{1 , 2} ] ;\end{matrix} v ∉ \{ 2 , 3 , 4 \} \\ [ \begin{matrix}{i}_{1 , 1} & {i}_{1 , 3} & {i}_{1 , 3} ] ;\end{matrix} v ∈ \{ 2 , 3 , 4 \}\end{matrix} \qquad Eq . 1$$

where v∈{1, 2, . . . , 8} is the number of transmission layers.

The overall DFT vector contains N1O1 and N2O2 beams span over the horizontal and vertical dimensions, where N1 and N2 are the number of the configured CSI-RS ports in the horizontal and vertical dimensions, respectively, and O1 and O2 are their configured oversampling ratios to increase spatial resolution for beamforming. In this indication process, indices i_{1,1} and i_{1,2} select the best beam(s) in horizontal and vertical direction that are spanned by the (N1, O1) and (N2, O2) pairs, respectively. For when v∈{2,3,4}, i_{1,3} is used to pick orthogonal beams between layers 1/2 and 3/4. Further, index i₂ is to select one of the 4 phase values for inter-polarization co-phasing.

If the NR DL Type I codebook is used as the basis for design of the codebook for uplink transmission, one or more of the following may be employed. A WTRU may declare its coherence capability to indicate its suitability for use of DL Type I codebook, as for non-fully coherent WTRUs, other codebooks may be used. If a WTRU is not fully coherent, a WTRU may indicate the number of antenna groups for the purpose of indication of the need for co-phasing. In an example solution, a WTRU may also indicate supported N1, and N2 values according to its antenna structure. In a further example solution, a WTRU may be indicated to use a smaller value than the indicated N1 and N2 values. In an additional or an alternative solution, N1 and N2 values may be fixed. In another example solution, a WTRU may also indicate supported O1, and O2 values according to its antenna structure. In a further example solution, a WTRU may be indicated to use a smaller value than the indicated O1 and O2 values. In an additional or an alternative solution, O1 and O2 values may be fixed. In an example solution, a WTRU may apply co-phasing if WTRU has indicated that there are more than one antenna group, in other words, Ng>1.

Examples and embodiments following include codebook size reduction. The total number of precoders in a codebook may be a function of the number of co-phases. The number of precoders in a codebook can be reduced by half when the number of co-phases is reduced by half. The number of precoders can also be reduced by using a subset of precoders. Reducing the number of co-phases and/or using a subset of precoders may be termed as codebook subset restriction. The codebook subset restriction may be applied on an antenna group itself, or precoding choices per antenna group.

In an example, N number of co-phases may be determined using e^{j2πn/N}, where n=0, . . . , N−1. For choosing a smaller number of co-phases M, one may perform the following. One may generate a smaller number of co-phases M, by substituting N with M, as e^{j2πm/M} where m=0, . . . , M−1 and M<N. Additionally or alternatively, one may extract a subset of M co-phases from a set of N co-phases.

A WTRU may receive a CSI reporting configuration, where the configuration indicates the WTRU to generate a sub-codebook as a function of a parent codebook and a set of restriction rules. For codebook subset restriction, one or more of the following may apply.

In examples, the WTRU may perform sub-codebook creation by reducing the number of co-phases. In an example solution, a WTRU may indicate a preferred number of co-phases M in the uplink control information (UCI). In an example, WTRU may determine and report a preferred value of M based on its hardware capability, for example, a WTRU may not be able to generate a certain set of precoders resulting from the use of a higher value of M, due to its hardware limitation/hardware impairments.

In another example solution, a WTRU may indicate a maximum number of co-phases M_max as part of its capabilities. Then, a WTRU may receive a value of M, where the configured value of M may be less than or equal to M_max. The received value of M may be RRC configured, for example, in a CSI reporting configuration or dynamically indicated by MAC-CE and/or DCI.

In examples, the WTRU may perform sub-codebook creation by extracting precoders from a parent codebook. In an example a WTRU may create a sub-codebook by extracting a preferred number of precoders from a parent codebook. In an example, a WTRU may extract a preferred number of precoders for eight antenna transmission from a parent codebook of sixteen antenna transmission. In another example, a WTRU may extract a preferred number of precoders for eight antenna transmission from a parent codebook of thirty-two antenna transmission.

The number of precoders in the sub-codebook may be based on WTRU capability and/or use-case, for example, URLLC or eMBB and/or operational conditions, for example, channel quality indicator (CQI), signal to interference and noise ratio (SINR), available power, distance between the precoders, and the like.

A WTRU may indicate one or more of the following in the UCI: the number of precoders in the sub-codebook; the precoder indices extracted from the parent codebook; the precoder indices may be indicated using a bitmap, with the number of bits in the bitmap equal to the number of precoders in the parent codebook; or the parameters setting of the parent codebook. A bit value “1” in the bitmap may correspond to the index of a precoder in the parent codebook included in the sub-codebook. Also, a bit value “0” in the bitmap may correspond to the index of a precoder in the parent codebook which is excluded in the sub-codebook. In examples, the parameters setting of the parent codebook may include one or more of: the number of antennas on the panel; the number of panels; the DFT oversampling factors or the number of co-phases used in the parent codebook.

Additionally or alternatively, a WTRU may receive one or more of the above-mentioned indications through an RRC configuration and/or MAC-CE and/or DCI.

In another example solution, a WTRU may create a sub-codebook by extracting a certain number of non-co-phased precoders from a parent codebook, where the non-co-phased precoders may be defined as the set of precoders with a co-phase of e^{j2πm/M} at m=0. Additionally or alternatively, the non-co-phased precoders may also be defined as the set of precoders with a co-phase of zero radian/degree.

The extraction of the non-co-phased precoders from a parent codebook may be based on WTRU capability, hardware limitation/hardware impairments and/or use-case, for example, URLLC or eMBB and/or operational conditions, for example, CQI, SINR, available power, and the like.

A WTRU may indicate one or more of the following in the UCI: the number of non-co-phased precoders in the sub-codebook; the non-co-phased precoder indices extracted from the parent codebook; or the parameters setting of the parent codebook. A bit value “1” in the bitmap may correspond to the index of a non-co-phased precoder in the parent codebook included in the sub-codebook. Further, a bit value “0” in the bitmap may correspond to the index of a non-co-phased precoder in the parent codebook which is excluded in the sub-codebook. In examples, the parameters setting of the parent codebook may include one or more of: the number of antennas on the panel, the number of panels, or the DFT oversampling factors.

Additionally or alternatively, a WTRU may receive one or more of the above-mentioned indications through an RRC configuration and/or MAC-CE or DCI.

In examples, the WTRU may perform sub-codebook creation by maximizing distances between the precoders. In an example solution, a sub-codebook may be created based on the distance between precoders of a parent codebook. In an example, a sub-codebook may be created by maximining Eq. 2, where Aᵢ is the i_th and Aⱼ is the j_th precoder of a parent codebook, respectively. A WTRU may create a sub-codebook of M precoders by extracting M precoders with the largest distance based on Eq. 2.

$$max ∀ i , j {‖ {A}_{i} - {A}_{j} ‖}^{2} , i \neq j \qquad Eq . 2$$

A WTRU may indicate the precoder indices of the parent codebook, included in the sub-codebook in the UCI. A WTRU may indicate the parameter settings of the parent codebook in the UCI. A WTRU may receive indication of the procedure indices of the parent codebook, included in the sub-codebook using an RRC configuration and/or MAC-CE and/or DCI.

In another example solution, a WTRU may determine the value for co-phases based on the criteria of maximizing the distances between the precoders. In an example, based on the criteria of maximizing the distances between the precoders. In an example, optimal values of the co-phases for a total of two co-phases is 0 and π radians. In another example, optimal values of the co-phases for a total of four co-phases is 0, π/2, π, and 3π/2 radians.

In another example solution, a WTRU may create a sub-codebook of precoders from a parent codebook based on maximizing the distance between two complex entries of the precoders. In an example, a WTRU may only include a set of precoders in the codebook based on the distance between two consecutive complex elements of the codebook. In another example, a WTRU may only include a set of precoders in the codebook based on one or more of the distance between the first two complex entries of the precoder, distance between the third and fourth complex entries of the precoder, or distance between the second and third entries of the precoder.

In examples, the WTRU may perform sub-codebook creation by exploiting correlation. In an example solution, a WTRU may determine a sub-codebook of precoders from a parent codebook based on correlation among the precoders. A WTRU may determine a set of M precoders from N precoders based on the criteria of minimizing the correlation among the set of M precoders. Minimum correlation among the set of M precoders may be realized by extracting precoders from a parent codebook and/or choosing proper values of co-phases.

In another example solution, a WTRU may be configured with only a subset of co-phases. In an example, a WTRU may be restricted to use only a subset of co-phases, extracted from a set of co-phases. The subset of co-phases may be selected based on various requirements, such as, for example, any one or any combination of the following: the WTRU ability of generating the co-phase basis functions; hardware complexity/limitation and/or hardware impairments; channel quality and/or interference; minimizing correlation among the precoders; minimizing correlation among precoders in the presence of spatial correlation among the antenna elements; or minimizing the correlation among precoders in the presence of spatial correlation among the antenna elements and channel impairments, and the like.

A WTRU may indicate the subset of co-phases in UCI. Additionally or alternatively, a WTRU may receive an indication of the subset of co-phases using one or more of an RRC configuration, a dynamic MAC-CE indication, or DCI indication.

In another example solution, a WTRU may create a sub-codebook from a defined set of complex symbols. In an example solution, a codebook of precoders may be created from a set of pre-defined values. In an example, a codebook with 8 precoders from pre-defined complex values, for example, 1+0j, −1+0j may be created as follows.

A codebook with 8 precoders for 3 antenna transmission with pre-defined values, for example 1+0j and −1+0j may be obtained as follows.

$$G = [ \begin{matrix}- 1 & - 1 & - 1 & - 1 & 1 & 1 & 1 & 1 \\ - 1 & - 1 & 1 & 1 & - 1 & - 1 & 1 & 1 \\ - 1 & 1 & - 1 & 1 & - 1 & 1 & - 1 & 1\end{matrix} ] \qquad Eq . 3$$

Further, a codebook may be created based on different metrics, as shown in the following examples. For example, a codebook may be created based on chordal distance between entries of each column, for example, chordal distance between the first value of the first column and the second value of the first column and/or chordal distance between the second value of the first column and the third value of the first column and/or chordal distance between the first column and the second column and/or chordal distance between the first row and the second row. In another example, a codebook may be created based on correlation between the columns of the matrix G and/or correlation between the rows of the parent codebook G.

An example of a sub-codebook H with 4 precoders extracted from the parent codebook G based on maximizing the chordal distance may be obtained as follows.

$$H = [ \begin{matrix}1 & 1 & - 1 & 1 \\ - 1 & 1 & 1 & - 1 \\ - 1 & - 1 & - 1 & 1\end{matrix} ] \qquad Eq . 4$$

Examples and embodiments following include selection criteria for choosing a sub-codebook from a parent codebook. An exemplary parent codebook for 1 layer with [N1, N2, O1, O2]=[4, 1, 2, 1] and 4 co-phases can be created using Type-1 single-panel codebook. A sub-codebook may be drawn from a parent codebook based on one or more of the following.

In an example, the codebook may be based on a first criterion or set of criteria. For example, a set of precoders may be extracted from a parent codebook based on one or more of the following. In an example, only precoders made of certain complex symbols may be extracted from a parent codebook. In an example, precoders made of quadrature phase shift keying (QPSK) symbols (e.g., [1,−1,1j,−1j]) may be extracted from the parent codebook. In another example, precoders made of binary phase-shift keying (BPSK) symbols, for example, [1,−1], may be extracted from the parent codebook.

In a further example, a precoder, for example, a precoder of N elements [a1, a2, . . . a_N], may only be extracted from a parent codebook if the phase offset between a_n and a_(n+1) is greater than or equal to a threshold (for example, phase offset between a_(n) and a_(n+1) is greater than or equal to threshold_a) and/or phase offset between a_(n−1) and a_(n) is greater than or equal to a threshold (for example, phase offset between a_(n−1) and a_(n) is greater than or equal to threshold_b).

In an additional or alternative example, a precoder, for example, a precoder of N elements [a1, a2, . . . a_N], may only be extracted from a parent codebook if the phase offset between a_(n) and a_(n+1) is not equal to the phase offset between a_(n+1) and a_(n+2).

In a further example, the codebook may be based on a second criterion or set of criteria. For example, a set of precoders can be extracted from a parent codebook with a higher number of co-phases, and the extraction may be based on the criteria of minimum correlation among the precoders. For example, a correlation coefficient may be determined for each precoder in a parent codebook against all the precoders of the codebook of the 32 precoders in the parent codebook are correlated across each other and 16 precoders with the minimum correlation are extracted from the parent codebook. Based on the correlation coefficients of the precoders, a set of precoders may be drawn from the parent codebook.

In another example, the codebook may be based on a third criterion or set of criteria. For example, the set of precoders may be extracted from a parent codebook, based on one or more of the following. The set of precoders are drawn from the parent codebook based on the maximum chordal distance between each point of the precoder. In an example, for a precoder [a,b,c,d]\hat{ }T, the chordal distance of the precoder may be determined as mean (chord (a,b)+chord (a,c)+chord (a,d)+chord (b,c)+chord (b,d)+chord (c,d), where chord (a,b) is the chordal distance between entry a and entry b of the precoder. In another example, the chordal distance of the precoder may be determined as mean (chord (a,b)+chord (b,c)+chord (c,d).

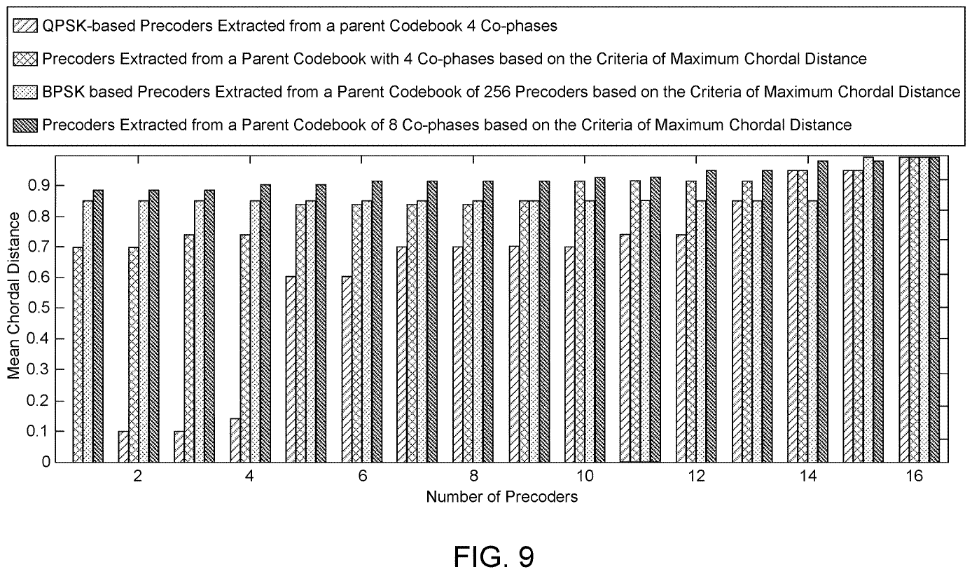

FIG. 9 is a graph diagram illustrating an example of a comparison of mean chordal distance using different selection criteria. An example as shown in FIG. 9 includes a comparison of mean chordal distance of different resulting codebooks using different selection criteria.

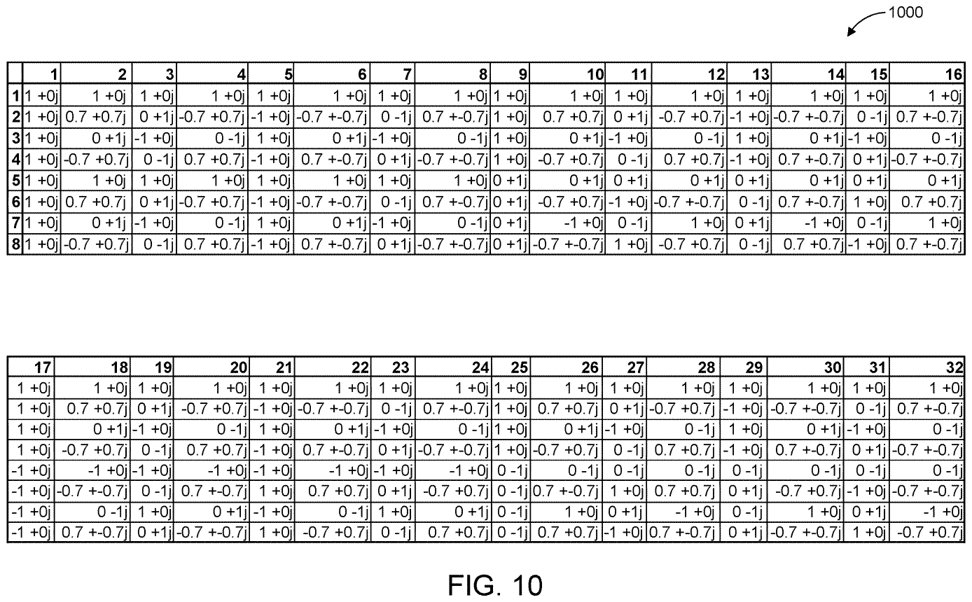

FIG. 10 is a codebook diagram illustrating an example of a DL codebook at a parent codebook with precoders. In an example case shown in codebook diagram 1000, a DL codebook may be used as a parent codebook. In an example, the parent codebook may be an NR DL codebook. For example, a DL Type-I codebook of 32 precoders with [N1, N2, O1, O2]=[4, 1, 2, 1] and 4 co-phases may be considered as the parent codebook that includes 32 rank=1 precoders. The 32 precoders are shown in FIG. 10 by the 32 columns. The 8 rows may provide the precoders used by up to 8 antennas.

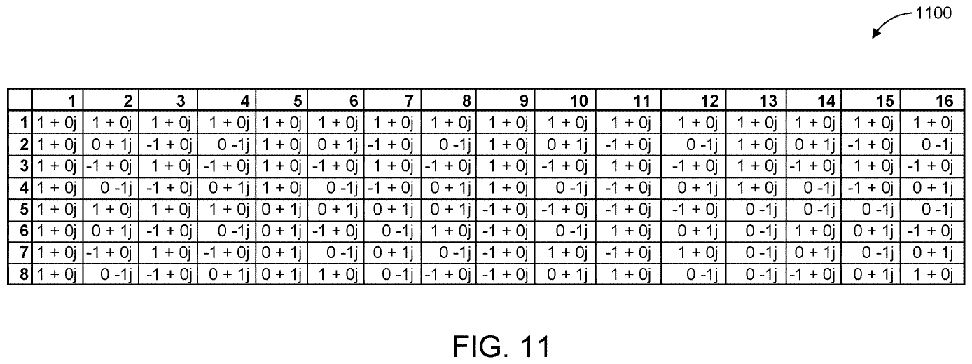

FIG. 11 is a codebook diagram illustrating an example of a reduced codebook. In an example solution shown in codebook diagram 1100, to reduce the codebook size, different criteria may be used to prune the codebook. In an exemplary solution, only QPSK-based precoders may be extracted from a Type-I codebook of 32 precoders with [N1, N2, O1, O2]=[4, 1, 2, 1] and 4 co-phases. Accordingly, 16 QPSK-based precoders are shown in FIG. 11 by the 16 columns. As with FIG. 10, the 8 rows may provide the precoders used by up to 8 antennas.

Examples of multiple codebook construction and selection are included herein. In an example solution, a precoding codebook for ranks R>1, may be constructed based on a set of rank R=1 precoders. For example, a rank R=2 codebook may be realized by collecting different pairs of N rank R=1 precoders.

In an example solution, a WTRU may implicitly indicate its supported codebook according to its antenna layout or number of antenna groups. In an exemplary solution, a WTRU may implicitly or explicitly indicate one of the antenna layout cases shown in FIG. 3 as its supported antenna layout. Then, according to the indicated antenna layout, a WTRU may implicitly indicate to a gNB or base station and use one of the supported codebook.

In an example solution, a WTRU may be configured, indicated or implemented to support more than one codebooks, where each codebook may be referenced by an index. Each codebook may be per supported rank, or alternatively may contain all the supported ranks. In an exemplary solution, a WTRU may be semi-statically or dynamically instructed to use one of the codebooks for its uplink transmission.

In an example solution, a WTRU configured with an SRS resource set containing at least one N_{SRS}-port SRS resource may be triggered to perform SRS transmission. The SRS transmission may be performed by simultaneous transmission from N_{SRS} ports, or alternatively it may be done sequentially in N_{SRS} intervals where in each interval one of its non-coherent precoders is applied for transmission. In a solution, the SRS transmission may be in a periodic or aperiodic manner. Following the SRS transmission, a WTRU may receive an indication, for example, an index to select one of the configured codebooks. In an exemplary solution, a WTRU may be RRC configured to use a codebook. Additionally or alternatively, a WTRU may receive a MAC CE or a DCI indication to activate a codebook. In another solution, a WTRU may receive a codebook selection indicator in the same scheduling DCI that carries the TPMI.

In an example solution, an 8 Tx WTRU may support the following non-coherent precoders for its rank R=1 uplink transmission.

$$[ \begin{matrix}1 \\ 0 \\ 0 \\ 0 \\ 0 \\ 0 \\ 0 \\ 0\end{matrix} ] , [ \begin{matrix}0 \\ 1 \\ 0 \\ 0 \\ 0 \\ 0 \\ 0 \\ 0\end{matrix} ] , [ \begin{matrix}0 \\ 0 \\ 1 \\ 0 \\ 0 \\ 0 \\ 0 \\ 0\end{matrix} ] , [ \begin{matrix}0 \\ 0 \\ 0 \\ 1 \\ 0 \\ 0 \\ 0 \\ 0\end{matrix} ] , [ \begin{matrix}0 \\ 0 \\ 0 \\ 0 \\ 1 \\ 0 \\ 0 \\ 0\end{matrix} ] , [ \begin{matrix}0 \\ 0 \\ 0 \\ 0 \\ 0 \\ 1 \\ 0 \\ 0\end{matrix} ] , [ \begin{matrix}0 \\ 0 \\ 0 \\ 0 \\ 0 \\ 0 \\ 1 \\ 0\end{matrix} ] , [ \begin{matrix}0 \\ 0 \\ 0 \\ 0 \\ 0 \\ 0 \\ 0 \\ 1\end{matrix} ]$$

For example, for rank R=2 transmission, different combinations and permutations of rank R=1 precoders may be considered, where each codebook may be considered for a different WTRU antenna layout, or transmission environment. For example, as shown below, using the rank R=1 precoders, more than one rank R=2 codebooks may be considered.
Rank R=2, Codebook-1:

$$[ \begin{matrix}00 \\ 00 \\ 01 \\ 00 \\ 10 \\ 00 \\ 00 \\ 00\end{matrix} ] , [ \begin{matrix}01 \\ 00 \\ 00 \\ 00 \\ 00 \\ 10 \\ 00 \\ 00\end{matrix} ] , [ \begin{matrix}00 \\ 00 \\ 00 \\ 00 \\ 01 \\ 00 \\ 10 \\ 00\end{matrix} ] , [ \begin{matrix}00 \\ 00 \\ 00 \\ 00 \\ 01 \\ 00 \\ 00 \\ 10\end{matrix} ]$$

Rank R=2, Codebook-2:

$$[ \begin{matrix}01 \\ 10 \\ 00 \\ 00 \\ 00 \\ 00 \\ 00 \\ 00\end{matrix} ] , [ \begin{matrix}01 \\ 00 \\ 10 \\ 00 \\ 00 \\ 00 \\ 00 \\ 00\end{matrix} ] , [ \begin{matrix}01 \\ 00 \\ 00 \\ 10 \\ 00 \\ 00 \\ 00 \\ 00\end{matrix} ]$$

For example, for a rank R=2 transmission, a WTRU with antenna layout shown as Case 1-b in FIG. 3 may use a first codebook, while another WTRU with antenna configuration shown as Case 3-a may use a second codebook. Further, in another example, a WTRU with an antenna layout configuration Case 3-a, it may use a first codebook in one deployment, for example, an indoor scenario, while it may use a second codebook for another deployment/channel, for example, an outdoor scenario.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
determining one or more precoding codebooks;
receiving downlink control information (DCI) scheduling an uplink transmission, wherein the DCI includes rank information, precoder information, a first indication associated with a first codeword (CW), and a second indication;
determining, based on the rank information, a subset of the one or more precoding codebooks;
determining, on a condition that the rank information indicates that a rank is less than or equal to a threshold value, a precoder from the subset of the one or more precoding codebooks, based on the precoder information and at least part of the second indication;
determining, on a condition that the rank information indicates that the rank is greater than the threshold value, the precoder based on the precoder information, and that the second indication is associated with a second CW, wherein the second indication indicates a redundancy version (RV); and
transmitting, based on the first indication and using the precoder, the first CW in the uplink transmission.

2. (canceled)

3. The method of claim 1, wherein the second indication is associated with precoder selection.

4. The method of claim 1, wherein the threshold value is four (4).

5. The method of claim 1, wherein, on a condition that the rank information indicates the rank is less than or equal to the threshold value, the second indication is associated with precoder selection.

6. (canceled)

7. The method of claim 1, on a condition that the rank information indicates that the rank is greater than the threshold value, further comprising:
transmitting, based on the second indication, the second CW using the precoder information.

8. The method of claim 7, wherein the second indication indicates a modulation and coding scheme (MCS).

9. (canceled)

10. The method of claim 7, wherein, the second indication indicates whether new data is to be transmitted.

11. A wireless transmit/receive unit (WTRU), the WTRU comprising:
a transceiver; and
a processor operatively coupled to the transceiver; wherein
the processor is configured to determine one or more precoding codebooks;
the transceiver is configured to receive downlink control information (DCI) scheduling an uplink transmission, wherein the DCI includes rank information, precoder information, a first indication associated with a first codeword (CW), and a second indication;
the processor is configured to determine, based on the rank information, a subset of the one or more precoding codebooks;
the processor is configured to determine, on a condition that the rank information indicates that a rank is less than or equal to a threshold value, a precoder from the subset of the one or more precoding codebooks, based on the precoder information and at least part of the second indication;
the processor is configured to determine, on a condition that the rank information indicates that the rank is greater than the threshold value, the precoder based on the precoder information, and that the second indication is associated with a second CW, wherein the second indication indicates a redundancy version (RV); and
the processor and the transceiver are configured to transmit, based on the first indication and using the precoder, the first CW in the uplink transmission.

12. (canceled)

13. The WTRU of claim 11, wherein the second indication is associated with precoder selection.

14. The WTRU of claim 11, wherein the threshold value is four (4).

15. The WTRU of claim 11, wherein, on a condition that the rank information indicates the rank is less than or equal to the threshold value, the second indication is associated with precoder selection.

16. (canceled)

17. The WTRU of claim 11, wherein the processor and the transceiver are further configured to transmit, on a condition that the rank information indicates that the rank is greater than the threshold value, based on the second indication, the second CW using the precoder information.

18. The WTRU of claim 17, wherein the second indication indicates a modulation and coding scheme (MCS).

19. (canceled)

20. The WTRU of claim 17, wherein the second indication indicates whether new data is to be transmitted.
